(19) United States
(12) Patent Application Publication
(10) Pub. No.: US 2026/0040351 A1
(43) Pub. Date: Feb. 5, 2026

(54) ENTITY IN A WIRELESS COMMUNICATION SYSTEM AND METHOD PERFORMED BY THE SAME

(71) Applicant: Samsung Electronics Co., Ltd., Suwon-si, Gyeonggi-do (KR)

(72) Inventors: Yanru WANG, Beijing (CN); Lixiang XU, Beijing (CN); Hong WANG, Beijing (CN); Weiwei WANG, Beijing (CN)

(21) Appl. No.: 18/998,042

(22) PCT Filed: Jul. 25, 2023
(86) PCT No.: PCT/KR2023/010768

§ 371 Date: Jan. 23, 2025

(30) Foreign Application Priority Data
Jul. 25, 2022 (CN) 202210884311.3
Sep. 23, 2022 (CN) 202211167818.3
Dec. 22, 2022 (CN) 202211672608.X
Jun. 30, 2023 (CN) 202310798277.2

(51) Int. Cl. H04W 74/0808; H04W 24/04

(52) U.S. Cl. CPC H04W 74/0808; H04W 24/04

(57) ABSTRACT

The present disclosure is related to a 5G or 6G communication system, which is after 4G communication system such as an LTE, for supporting higher data transmission ratio, provides an entity in a wireless communication system and a method performed by the same. A method performed by a first entity in a wireless communication system according to an embodiment of the present disclosure may comprise: transmitting, to a second entity. a request of reporting at least one information, wherein the request includes time information indicating a time point to which prediction of the at least one information is applied; and receiving, from the second entity. a response including information regarding the reporting of the at least one information, based on the request.

### TECHNICAL FIELD

The present disclosure relates to the technical field of wireless communication, and more specifically, to an entity in a wireless communication system and a method performed by the same.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service arca expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### DISCLOSURE OF INVENTION

### Solution to Problem

Embodiments of the present disclosure provide a method performed by a first entity in a wireless communication system, comprising: transmitting, to a second entity, a request of reporting at least one information, wherein the request includes time information indicating a time point to which prediction of the at least one information is applied; and receiving, from the second entity, a response including information regarding the reporting of the at least one information, based on the request.

Embodiments of the present disclosure provide a method performed by a second entity in a wireless communication system, comprising: receiving, from a first entity, a request of reporting at least one information, wherein the request includes time information indicating a time point to which prediction of the at least one information is applied; and transmitting, to the first entity, a response including information regarding the reporting of the at least one information, based on the request.

Embodiments of the present disclosure provide a first entity in a wireless communication system, comprising: a transceiver; and a processor coupled to the transceiver and configured to perform methods performed by a first entity in a wireless communication system according to embodiments of the present disclosure.

Embodiments of the present disclosure provide a second entity in a wireless communication system, comprising: a transceiver; and a processor coupled to the transceiver and configured to perform methods performed by a second entity in a wireless communication system according to embodiments of the present disclosure.

### BRIEF DESCRIPTION OF DRAWINGS

The above and other aspects, features and advantages of certain embodiments of the present disclosure will be more apparent from the following description taken in conjunction with the accompanying drawings, in which:

FIG. 1 is an exemplary system architecture 100 of System Architecture Evolution (SAE);

FIG. 2 is an exemplary system architecture 200 according to various embodiments of the present disclosure;

FIG. 3 illustrates a flowchart of a method 300 performed by a first entity in a wireless communication system according to embodiments of the present disclosure;

FIG. 4 illustrates a flowchart of a method 400 performed by a second entity in a wireless communication system according to embodiments of the present disclosure;

FIG. 5a illustrates a schematic diagram of an aspect of a method for supporting self-optimization of a wireless communication network according to embodiments of the present disclosure;

FIG. 5b illustrates a schematic diagram of an aspect of a method for supporting self-optimization of a wireless communication network according to embodiments of the present disclosure;

FIG. 6a illustrates a schematic diagram of an aspect of a method for supporting self-optimization of a wireless communication network according to embodiments of the present disclosure;

FIG. 6b illustrates a schematic diagram of an aspect of a method for supporting self-optimization of a wireless communication network according to embodiments of the present disclosure;

FIG. 7a illustrates a schematic diagram of an aspect of a method for supporting self-optimization of a wireless communication network according to embodiments of the present disclosure;

FIG. 7b illustrates a schematic diagram of an aspect of a method for supporting self-optimization of a wireless communication network according to embodiments of the present disclosure;

FIG. 8 illustrates a schematic diagram of an aspect of a method for supporting self-optimization of a wireless communication network according to embodiments of the present disclosure;

FIG. 9a illustrates a schematic diagram of an aspect of a method for supporting self-optimization of a wireless communication network according to embodiments of the present disclosure;

FIG. 9b illustrates a schematic diagram of an aspect of a method for supporting self-optimization of a wireless communication network according to embodiments of the present disclosure;

FIG. 9c illustrates a schematic diagram of an aspect of a method for supporting self-optimization of a wireless communication network according to embodiments of the present disclosure;

FIG. 10a illustrates a schematic diagram of an aspect of a method for supporting self-optimization of a wireless communication network according to embodiments of the present disclosure;

FIG. 10b illustrates a schematic diagram of an aspect of a method for supporting self-optimization of a wireless communication network according to embodiments of the present disclosure;

FIG. 10c illustrates a schematic diagram of an aspect of a method for supporting self-optimization of a wireless communication network according to embodiments of the present disclosure;

FIG. 10d illustrates a schematic diagram of an aspect of a method for supporting self-optimization of a wireless communication network according to embodiments of the present disclosure;

FIG. 10e illustrates a schematic diagram of an aspect of a method for supporting self-optimization of a wireless communication network according to embodiments of the present disclosure;

FIG. 10f illustrates a schematic diagram of an aspect of a method for supporting self-optimization of a wireless communication network according to embodiments of the present disclosure;

FIG. 10g illustrates a schematic diagram of an aspect of a method for supporting self-optimization of a wireless communication network according to embodiments of the present disclosure;

FIG. 11 illustrates a schematic diagram of a first entity 1100 according to embodiments of the present disclosure; and

FIG. 12 illustrates a schematic diagram of a second entity 1200 according to embodiments of the present disclosure.

### MODE FOR THE INVENTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The term “include” or “may include” refers to the existence of a corresponding disclosed function, operation or component which can be used in various embodiments of the present disclosure and does not limit one or more additional functions, operations, or components. The terms such as “include” and/or “have” may be construed to denote a certain characteristic, number, step, operation, constituent element, component or a combination thereof, but may not be construed to exclude the existence of or a possibility of addition of one or more other characteristics, numbers, steps, operations, constituent elements, components or combinations thereof.

The term “or” used in various embodiments of the present disclosure includes any or all of combinations of listed words. For example, the expression “A or B” may include A, may include B, or may include both A and B.

Unless defined differently, all terms used herein, which include technical terminologies or scientific terminologies, have the same meaning as that understood by a person skilled in the art to which the present disclosure belongs. Such terms as those defined in a generally used dictionary are to be interpreted to have the meanings equal to the contextual meanings in the relevant field of art, and are not to be interpreted to have ideal or excessively formal meanings unless clearly defined in the present disclosure.

In order to meet an increasing demand for wireless data communication services since a deployment of 4G communication system, efforts have been made to develop an improved 5G or pre-5G communication system. Therefore, the 5G or pre-5G communication system is also called “beyond 4G network” or “post LTE system”.

Wireless communication is one of the most successful innovations in modern history. Recently, a number of subscribers of wireless communication services has exceeded 5 billion, and it continues growing rapidly. With the increasing popularity of smart phones and other mobile data devices (such as tablet computers, notebook computers, netbooks, e-book readers and machine-type devices) in consumers and enterprises, a demand for wireless data services is growing rapidly. In order to meet rapid growth of mobile data services and support new applications and deployments, it is very important to improve efficiency and coverage of wireless interfaces.

In the new radio-unlicensed (NR-U), a competition mechanism of Listen Before Talk (LBT) is adopted on each resource chunk and/or channel. Herein, a resource chunk may refer to a 20 MHz time-frequency resource.

A base station can provide reference information to assist decision-making of mobile load balancing by interacting load information of nodes.

The base station can collect and/or interact with user radio link related information and/or reports of users to provide reference information to assist decision-making of mobile robust optimization.

Embodiments of the present disclosure provide a method performed by a first entity in a wireless communication system, including: receiving at least one piece of information of information related to Listen Before Talk (LBT) energy detection threshold, information related to signal strength and/or signal quality, information related to resource status and/or load situation of an unlicensed band and/or a licensed band, information related to LBT failure detection information and/or LBT failure detection result and LBT failure information from a second entity, and/or transmitting information including a configuration of conditions for channel busy status checking to the second entity, wherein the at least one piece of information is associated with at least one of the second entity and other entities except the first entity and the second entity.

According to embodiments of the present disclosure, the method performed by the first entity in the wireless communication system further includes: transmitting first information including LBT energy detection threshold collection and/or reporting configuration to the second entity, wherein the information related to LBT energy detection threshold is acquired and/or transmitted to the first entity by the second entity based on the first information, wherein the first information includes one or more of the following: user equipment identification, transmitting entity identification, receiving entity identification, energy detection threshold reporting indication, energy detection threshold reporting mode, energy detection threshold reporting interval, energy detection threshold reporting time, energy detection threshold collecting interval, energy detection threshold collection time, energy detection threshold measuring interval, energy detection threshold measuring time, energy detection threshold reporting start indication, energy detection threshold reporting end and/or stop indication, energy detection threshold reporting trigger event, maximum energy detection threshold reporting indication, maximum energy detection threshold reporting mode, maximum energy detection threshold reporting interval, maximum energy detection threshold reporting time, maximum energy detection threshold collection interval, maximum energy detection threshold collection time, maximum energy detection threshold measuring interval, maximum energy detection threshold measuring time, maximum energy detection threshold reporting start indication, maximum energy detection threshold reporting end indication and maximum energy detection threshold reporting trigger event.

According to embodiments of the present disclosure, the method performed by the first entity in the wireless communication system further includes: receiving third information from the second entity, wherein the third information includes information indicating that the second entity cannot transmit the information related to LBT energy detection threshold to the first entity based on the first information, wherein the third information includes one or more of the following: user equipment identification, transmitting entity identification, receiving entity identification, indication for that energy detection threshold cannot be reported, indication for that maximum energy detection threshold cannot be reported, cause for that energy detection threshold and/or maximum energy detection threshold cannot be reported.

According to embodiments of the present disclosure, the method performed by the first entity in the wireless communication system further includes: transmitting fourth information including signal strength and/or signal quality collection and/or reporting configuration to the second entity, wherein the information related to signal strength and/or signal quality is acquired and/or transmitted to the first entity by the second entity based on the fourth information, wherein the fourth information includes one or more of the following: user equipment identification, transmitting entity identification, receiving entity identification, channel occupancy threshold, number of collected samples, maximum number of collected samples, minimum number of collected samples, sample collection time interval, maximum sample collection time interval and minimum sample collection time interval.

According to embodiments of the present disclosure, the method performed by the first entity in the wireless communication system further includes: transmitting sixth information including a request for resource status and/or load situation of an un-licensed band and/or a licensed band to the second entity, and receiving seventh information including a response to the request for resource status and/or load situation of the unlicensed band and/or the licensed band from the second entity, wherein the request for resource status and/or load situation of the unlicensed band and/or the licensed band is a request for the information related to resource status and/or load situation of the unlicensed band and/or the licensed band, wherein the sixth information includes one or more of the following: user equipment identification, transmitting entity identification, receiving entity identification, signal strength and/or signal quality reporting request, channel occupancy threshold, number of collected samples, maximum number of collected samples, minimum number of collected samples, sample collection time interval, maximum sample collection time interval, minimum sample collection time interval, service resource status and/or load reporting request, service indication, scope for requested reporting, data volume reporting request, time information corresponding to data volume reporting, time information corresponding to data volume measurement, measurement time information of reporting content, reporting content, prediction user equipment identification, un-licensed band prediction identification, prediction registration request, time interval for requested prediction, applicable time for requested prediction content, scope for requested prediction, prediction content, prediction reporting period, indication of that accuracy of result and/or prediction model needs to be reported, identification of support of partial reporting, indication of reporting necessity, condition and/or event for triggering reporting, and wherein the seventh information includes one or more of the following: user equipment identification, transmitting entity identification, receiving entity identification, prediction request confirmation, one-by-one prediction request content confirmation, reportable content, non-reportable content, reportable content scope, non-reportable content scope, cause for request failure, prediction confidence, and request failure indication.

According to embodiments of the present disclosure, the information including a configuration of conditions for channel busy status checking is included in ninth information, wherein the ninth information includes one or more of the following: user equipment identification, transmitting entity identification, receiving entity identification, signal strength and/or signal quality threshold, and channel busy percentage threshold.

According to embodiments of the present disclosure, the method performed by the first entity in the wireless communication system further includes: transmitting tenth information including LBT failure detection configuration to the second entity, wherein the information related to LBT failure detection information and/or LBT failure detection result is acquired and/or transmitted to the first entity by the second entity based on the tenth information, wherein the tenth information includes one or more of the following: user equipment identification, transmitting entity identification, receiving entity identification, LBT failure detection timer and maximum count of LBT failure instances.

According to embodiments of the present disclosure, the method performed by the first entity in the wireless communication system further includes: transmitting information related to LBT failure information request to the second entity, wherein the information related to LBT failure information request is included in thirteenth information, wherein the thirteenth information includes one or more of the following: user equipment identification, transmitting entity identification, receiving entity identification, LBT failure information request, LBT failure report request, continuous LBT failure information request and continuous LBT failure report request.

According to embodiments of the present disclosure, the method performed by the first entity in the wireless communication system further includes: receiving twelfth information including an indication that LBT failure information is available from the second entity, wherein the information related to LBT failure information request is transmitted to the second entity by the first entity based on the twelfth information, wherein the twelfth information includes one or more of the following: user equipment identification, transmitting entity identification, receiving entity identification, LBT failure information available, LBT failure report available, continuous LBT failure information available, and continuous LBT failure report available.

According to embodiments of the present disclosure, the LBT failure information is included in fourteenth information, wherein the fourteenth information is autonomously transmitted by the second entity or transmitted by the second entity based on received information related to LBT failure information request.

According to embodiments of the present disclosure, the at least one piece of information is used for at least one of the first entity and the second entity to make a network self-optimization decision, wherein the network self-optimization decision includes at least one of network energy saving, load balancing, coverage optimization, mobility optimization and management, network configuration formulation and/or network configuration updating.

According to embodiments of the present disclosure, the information related to Listen Before Talk (LBT) energy detection threshold is second information, wherein the second information includes one or more of the following: user equipment identification, transmitting entity identification, receiving entity identification, energy detection threshold, reporting mode for the energy detection threshold, collection time for the energy detection threshold, event triggering the energy detection threshold reporting, maximum energy detection threshold, reporting mode for the maximum energy detection threshold, collection time for the maximum energy detection threshold and event triggering the maximum energy detection threshold reporting.

According to embodiments of the present disclosure, the information related to signal strength and/or signal quality is included in fifth information, wherein the fifth information includes one or more of the following: user equipment identification, transmitting entity identification, receiving entity identification, used channel occupancy threshold, used number of collected samples, maximum number of collected samples, minimum number of collected samples, used sample collection time interval, maximum sample collection time interval, minimum sample collection time interval, signal strength and/or signal quality, channel occupancy time percentage, and cause for report failure.

According to embodiments of the present disclosure, the information related to resource status and/or load situation of an unlicensed band and/or a licensed band is included in eighth information, wherein the eighth information includes one or more of the following: user equipment identification, transmitting entity identification, receiving entity identification, signal strength and/or signal quality, used channel occupancy threshold, channel busy percentage, resource percentage, maximum energy detection threshold, service indication corresponding to reported information, reporting content, applicable time for reporting content, scope corresponding to reporting content, condition and/or event triggering the reporting, prediction content prediction identification, applicable time for prediction content, reported information of resource status and/or load, prediction result, scope corresponding to prediction result and prediction confidence.

According to embodiments of the present disclosure, the information related to LBT failure detection information and/or LBT failure detection result is included in eleventh information, wherein the eleventh information includes one or more of the following: user equipment identification, transmitting entity identification, receiving entity identification, serving cell identification, channel identification, LBT failure detection timer, maximum count of LBT failure instances, downlink LBT failure indication, uplink LBT failure indication and LBT failure indication.

According to embodiments of the present disclosure, the fourteenth information includes one or more of the following: user equipment identification, transmitting entity identification, receiving entity identification, received signal strength indicator (RSSI), channel occupancy time percentage, the number of LBT failure, success rate or failure rate of LBT, average transmission time duration after LBT success, LBT failure detection timer, maximum count of LBT failure instances, time length of LBT failure detection, count of LBT failure instances, downlink LBT failure indication, uplink LBT failure indication, LBT failure indication, bandwidth (BWP) where LBT failure occurs, resource configuration corresponding to LBT failure, resource activation configuration corresponding to LBT failure, RSSI corresponding to LBT failure, detected energy corresponding to LBT failure, energy detection threshold corresponding to LBT failure, maximum energy detection threshold corresponding to LBT failure, time information from LBT failure to reporting, time of LBT failure, cell identification, identification of a node where a cell is located, beam identification, slice identification, public land mobile network identification and band information indication.

Embodiments of the present disclosure provide a method performed by a second entity in a wireless communication system, including: transmitting at least one piece of information of information related to Listen Before Talk (LBT) energy detection threshold, information related to signal strength and/or signal quality, information related to resource status and/or load situation of an unlicensed band and/or a licensed band, information related to LBT failure detection information and/or LBT failure detection result and LBT failure information to a first entity, and/or receiving information including a configuration of conditions for channel busy status checking from the first entity, wherein the at least one piece of information is associated with at least one of the second entity and other entities except the first entity and the second entity.

According to embodiments of the present disclosure, the method performed by the second entity in the wireless communication system further includes: receiving first information including LBT energy detection threshold collection and/or reporting configuration from the first entity, wherein the information related to LBT energy detection threshold is acquired and/or transmitted to the first entity by the second entity based on the first information, wherein the first information includes one or more of the following: user equipment identification, transmitting entity identification, receiving entity identification, energy detection threshold reporting indication, energy detection threshold reporting mode, energy detection threshold reporting interval, energy detection threshold reporting time, energy detection threshold collecting interval, energy detection threshold collection time, energy detection threshold measuring interval, energy detection threshold measuring time, energy detection threshold reporting start indication, energy detection threshold reporting end and/or stop indication, energy detection threshold reporting trigger event, maximum energy detection threshold reporting indication, maximum energy detection threshold reporting mode, maximum energy detection threshold reporting interval, maximum energy detection threshold reporting time, maximum energy detection threshold collection interval, maximum energy detection threshold collection time, maximum energy detection threshold measuring interval, maximum energy detection threshold measuring time, maximum energy detection threshold reporting start indication, maximum energy detection threshold reporting end indication and maximum energy detection threshold reporting trigger event.

According to embodiments of the present disclosure, the method performed by the second entity in the wireless communication system further includes: transmitting third information to the first entity, wherein the third information includes information indicating that the second entity cannot transmit the information related to LBT energy detection threshold to the first entity based on the first information, wherein the third information includes one or more of the following: user equipment identification, transmitting entity identification, receiving entity identification, indication for that energy detection threshold cannot be reported, indication for that maximum energy detection threshold cannot be reported, cause for that energy detection threshold and/or maximum energy detection threshold cannot be reported.

According to embodiments of the present disclosure, the method performed by the second entity in the wireless communication system further includes: receiving fourth information including signal strength and/or signal quality collection and/or reporting configuration from the first entity, wherein the information related to signal strength and/or signal quality is acquired and/or transmitted to the first entity by the second entity based on the fourth information, wherein the fourth information includes one or more of the following: user equipment identification, transmitting entity identification, receiving entity identification, channel occupancy threshold, number of collected samples, maximum number of collected samples, minimum number of collected samples, sample collection time interval, maximum sample collection time interval and minimum sample collection time interval.

According to embodiments of the present disclosure, the method performed by the second entity in the wireless communication system further includes: receiving sixth information including a request for resource status and/or load situation of an un-licensed band and/or a licensed band from the first entity, and transmitting seventh information including a response to the request for resource status and/or load situation of the unlicensed band and/or the licensed band to the first entity, wherein the request for resource status and/or load situation of the unlicensed band and/or the licensed band is a request for the information related to resource status and/or load situation of the unlicensed band and/or the licensed band, wherein the sixth information includes one or more of the following: user equipment identification, transmitting entity identification, receiving entity identification, signal strength and/or signal quality reporting request, channel occupancy threshold, number of collected samples, maximum number of collected samples, minimum number of collected samples, sample collection time interval, maximum sample collection time interval, minimum sample collection time interval, service resource status and/or load reporting request, service indication, scope for requested reporting, data volume reporting request, time information corresponding to data volume reporting, time information corresponding to data volume measurement, measurement time information of reporting content, reporting content, prediction user equipment identification, unlicensed band prediction identification, prediction registration request, time interval for requested prediction, applicable time for requested prediction content, scope for requested prediction, prediction content, prediction reporting period, indication of that accuracy of result and/or prediction model needs to be reported, identification of support of partial reporting, indication of reporting necessity, condition and/or event for triggering reporting, and wherein the seventh information includes one or more of the following: user equipment identification, transmitting entity identification, receiving entity identification, prediction request confirmation, one-by-one prediction request content confirmation, reportable content, non-reportable content, reportable content scope, non-reportable content scope, cause for request failure, prediction confidence, and request failure indication.

According to embodiments of the present disclosure, the information including a configuration of conditions for channel busy status checking is included in ninth information, wherein the ninth information includes one or more of the following: user equipment identification, transmitting entity identification, receiving entity identification, signal strength and/or signal quality threshold, and channel busy percentage threshold.

According to embodiments of the present disclosure, the method performed by the second entity in the wireless communication system further includes: receiving tenth information including LBT failure detection configuration from the first entity, wherein the information related to LBT failure detection information and/or LBT failure detection result is acquired and/or transmitted to the first entity by the second entity based on the tenth information, wherein the tenth information includes one or more of the following: user equipment identification, transmitting entity identification, receiving entity identification, LBT failure detection timer and maximum count of LBT failure instances.

According to embodiments of the present disclosure, the method performed by the second entity in the wireless communication system further includes: receiving information related to LBT failure information request from the first entity, wherein the information related to LBT failure information request is included in thirteenth information, wherein the thirteenth information includes one or more of the following: user equipment identification, transmitting entity identification, receiving entity identification, LBT failure information request, LBT failure report request, continuous LBT failure information request and continuous LBT failure report request.

According to embodiments of the present disclosure, the method performed by the second entity in the wireless communication system further includes: transmitting twelfth information including an indication that LBT failure information is available to the first entity, wherein the information related to LBT failure information request is transmitted to the second entity by the first entity based on the twelfth information, wherein the twelfth information includes one or more of the following: user equipment identification, transmitting entity identification, receiving entity identification, LBT failure information available, LBT failure report available, continuous LBT failure information available, and continuous LBT failure report available.

According to embodiments of the present disclosure, the LBT failure information is included in fourteenth information, wherein the fourteenth information is autonomously transmitted by the second entity or transmitted by the second entity based on received information related to LBT failure information request.

According to embodiments of the present disclosure, the at least one piece of information is used for at least one of the first entity and the second entity to make a network self-optimization decision, wherein the network self-optimization decision includes at least one of network energy saving, load balancing, coverage optimization, mobility optimization and management, network configuration formulation and/or network configuration updating.

According to embodiments of the present disclosure, the information related to Listen Before Talk (LBT) energy detection threshold is second information, wherein the second information includes one or more of the following: user equipment identification, transmitting entity identification, receiving entity identification, energy detection threshold, reporting mode for the energy detection threshold, collection time for the energy detection threshold, event triggering the energy detection threshold reporting, maximum energy detection threshold, reporting mode for the maximum energy detection threshold, collection time for the maximum energy detection threshold and event triggering the maximum energy detection threshold reporting.

According to embodiments of the present disclosure, the information related to signal strength and/or signal quality is included in fifth information, wherein the fifth information includes one or more of the following: user equipment identification, transmitting entity identification, receiving entity identification, used channel occupancy threshold, used number of collected samples, maximum number of collected samples, minimum number of collected samples, used sample collection time interval, maximum sample collection time interval, minimum sample collection time interval, signal strength and/or signal quality, channel occupancy time percentage, and cause for report failure.

According to embodiments of the present disclosure, the information related to resource status and/or load situation of an unlicensed band and/or a licensed band is included in eighth information, wherein the eighth information includes one or more of the following: user equipment identification, transmitting entity identification, receiving entity identification, signal strength and/or signal quality, used channel occupancy threshold, channel busy percentage, resource percentage, maximum energy detection threshold, service indication corresponding to reported information, reporting content, applicable time for reporting content, scope corresponding to reporting content, condition and/or event triggering the reporting, prediction content prediction identification, applicable time for prediction content, reported information of resource status and/or load, prediction result, scope corresponding to prediction result and prediction confidence.

According to embodiments of the present disclosure, the information related to LBT failure detection information and/or LBT failure detection result is included in eleventh information, wherein the eleventh information includes one or more of the following: user equipment identification, transmitting entity identification, receiving entity identification, serving cell identification, channel identification, LBT failure detection timer, maximum count of LBT failure instances, downlink LBT failure indication, uplink LBT failure indication and LBT failure indication.

According to embodiments of the present disclosure, the fourteenth information includes one or more of the following: user equipment identification, transmitting entity identification, receiving entity identification, received signal strength indicator (RSSI), channel occupancy time percentage, the number of LBT failure, success rate or failure rate of LBT, average transmission time duration after LBT success, LBT failure detection timer, maximum count of LBT failure instances, time length of LBT failure detection, count of LBT failure instances, downlink LBT failure indication, uplink LBT failure indication, LBT failure indication, bandwidth (BWP) where LBT failure occurs, resource configuration corresponding to LBT failure, resource activation configuration corresponding to LBT failure, RSSI corresponding to LBT failure, detected energy corresponding to LBT failure, energy detection threshold corresponding to LBT failure, maximum energy detection threshold corresponding to LBT failure, time information from LBT failure to reporting, time of LBT failure, cell identification, identification of a node where a cell is located, beam identification, slice identification, public land mobile network identification and band information indication.

Embodiments of the present disclosure provide a first entity in a wireless communication system, including: a transceiver configured to transmit and receive signals; and a processor coupled to the transceiver and configured to perform methods performed by a first entity in a wireless communication system according to embodiments of the present disclosure.

Embodiments of the present disclosure provide a second entity in a wireless communication system, including: a transceiver configured to transmit and receive signals; and a processor coupled to the transceiver and configured to perform methods performed by a second entity in a wireless communication system according to embodiments of the present disclosure.

Embodiments of the present disclosure provide a computer-readable medium having stored thereon computer-readable instructions which, when executed by a processor, implement methods performed by a first entity and/or a second entity in a wireless communication system according to embodiments of the present disclosure.

The entities or nodes described in the present disclosure may include gNB, gNB Central Unit (gNB-CU), gNB Distributed Unit (gNB-DU), gNB Central Unit Control Plane (gNB CU-CP), gNB Central Unit User Plane (gNB CU-UP), en-gNB, eNB, ng-eNB, UE, Access and Mobility Management Function (AMF), Session Management Function (SMF), Mobility Management Entity (MME) and other network entities or network logic units.

The signal strength and/or signal quality described in the present disclosure may be a Received Signal Strength Indicator (RSSI), a Reference Signal Receiving Power (RSRP), a Reference Signal Receiving Quality (RSRQ), a Signal to Interference plus Noise Ratio (SINR), etc.

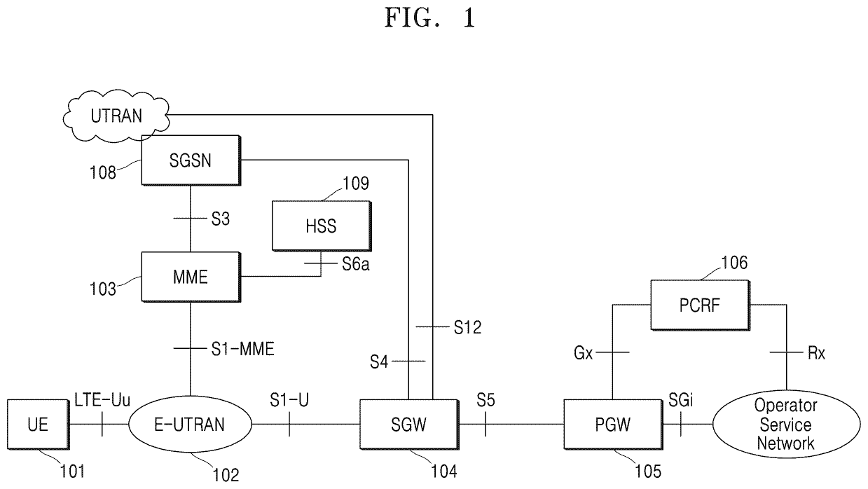

FIGS. 1 to 12 discussed below and various embodiments for describing the principles of the present disclosure in this patent document are only for illustration and should not be interpreted as limiting the scope of the present disclosure in any way. Those skilled in the art will understand that the principles of the present disclosure can be implemented in any suitably arranged system or device.

FIG. 1 is an exemplary system architecture 100 of system architecture evolution (SAE). User equipment (UE) 101 is a terminal device for receiving data. An evolved universal terrestrial radio access network (E-UTRAN) 102 is a radio access network, which includes a macro base station (eNodeB/NodeB) that provides UE with interfaces to access the radio network. A mobility management entity (MME) 103 is responsible for managing mobility context, session context and security information of the UE. A serving gateway (SGW) 104 mainly provides functions of user plane, and the MME 103 and the SGW 104 may be in the same physical entity. A packet data network gateway (PGW) 105 is responsible for functions of charging, lawful interception, etc., and may be in the same physical entity as the SGW 104. A policy and charging rules function entity (PCRF) 106 provides quality of service (QOS) policies and charging criteria. A general packet radio service support node (SGSN) 108 is a network node device that provides routing for data transmission in a universal mobile telecommunications system (UMTS). A home subscriber server (HSS) 109 is a home subsystem of the UE, and is responsible for protecting user information including a current location of the user equipment, an address of a serving node, user security information, and packet data context of the user equipment, etc.

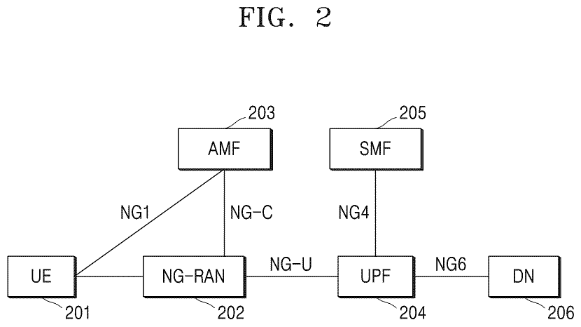

FIG. 2 is an exemplary system architecture 200 according to various embodiments of the present disclosure. Other embodiments of the system architecture 200 can be used without departing from the scope of the present disclosure.

User equipment (UE) 201 is a terminal device for receiving data. A next generation radio access network (NG-RAN) 202 is a radio access network, which includes a base station (a gNB or an eNB connected to 5G core network 5GC, and the eNB connected to the 5GC is also called ng-gNB) that provides UE with interfaces to access the radio network. An access control and mobility management function entity (AMF) 203 is responsible for managing mobility context and security information of the UE. A user plane function entity (UPF) 204 mainly provides functions of user plane. A session management function entity SMF 205 is responsible for session management. A data network (DN) 206 includes, for example, services of operators, access of Internet and service of third parties.

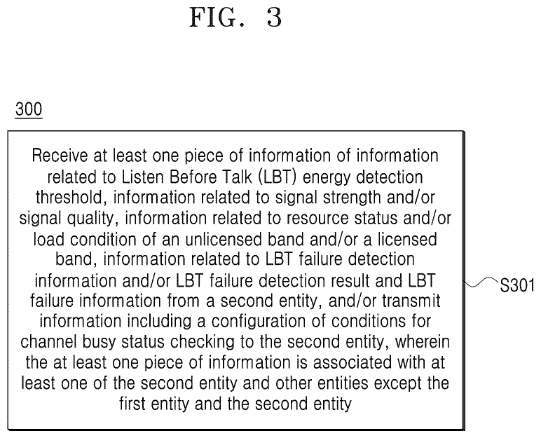

Next, FIG. 3 illustrates a flowchart of a method 300 performed by a first entity in a wireless communication system according to embodiments of the present disclosure.

As shown in FIG. 3, in step S301, the method 300 performed by a first entity in a wireless communication system according to embodiments of the present disclosure may include: receiving at least one piece of information of information related to Listen Before Talk (LBT) energy detection threshold, information related to signal strength and/or signal quality, information related to resource status and/or load situation of an unlicensed band and/or a licensed band, information related to LBT failure detection information and/or LBT failure detection result and LBT failure information from a second entity, and/or transmitting information including a configuration of conditions for channel busy status checking to the second entity. In some implementations, the at least one piece of information may be associated with at least one of the second entity and any other entity except the second entity. For example, the information related to Listen Before Talk (LBT) energy detection threshold received from the second entity may be energy detection threshold information of the second entity in an LBT process, or energy detection threshold information of any other entity in an LBT process collected or acquired by the second entity in any way. The other information described above has the same meaning, and will not be repeated here.

Additionally or alternatively, the method 300 may further include transmitting first information including LBT energy detection threshold collection and/or reporting configuration to the second entity. In some implementations, the information related to LBT energy detection threshold described above may be acquired and/or transmitted to the first entity by the second entity based on the LBT energy detection threshold collection and/or reporting configuration included in the first information.

Additionally or alternatively, the method 300 may further include receiving third information from the second entity, which may include information indicating that the second entity cannot transmit information related to LBT energy detection threshold to the first entity based on the first information.

Additionally or alternatively, the method 300 may further include transmitting fourth information including signal strength and/or signal quality collection and/or reporting configuration to the second entity. In some implementations, the information related to signal strength and/or signal quality described above may be acquired and/or transmitted to the first entity by the second entity based on the signal strength and/or signal quality collection and/or reporting configuration included in the fourth information.

Additionally or alternatively, the method 300 may further include transmitting sixth information including a request for resource status and/or load situation of an unlicensed band and/or a licensed band to the second entity, and receiving seventh information including a response to the request for resource status and/or load situation of the unlicensed band and/or the licensed band from the second entity. In some implementations, the request for resource status and/or load situation of the unlicensed band and/or the licensed band may be a request for information related to resource status and/or load situation of the unlicensed band and/or the licensed band.

Additionally or alternatively, the method 300 may further include transmitting ninth information including a configuration of conditions for channel busy status checking to the second entity.

Additionally or alternatively, the method 300 may further include transmitting tenth information including LBT failure detection configuration to the second entity. In some implementations, the information related to LBT failure detection information and/or LBT failure detection result described above may be acquired and/or transmitted to the first entity by the second entity based on the LBT failure detection configuration included in the tenth information.

Additionally or alternatively, the method 300 may further include receiving twelfth information including an indication that LBT failure information is available from the second entity, and transmitting information related to LBT failure information request to the second entity. In some implementations, the information related to LBT failure information request may be transmitted by the first entity to the second entity based on the indication that LBT failure information is available included in the twelfth information.

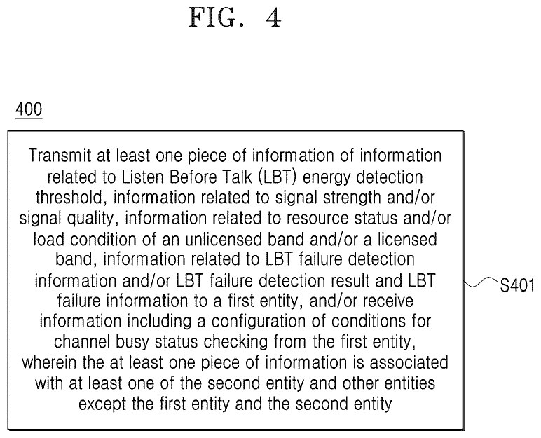

FIG. 4 illustrates a flowchart of a method 400 performed by a second entity in a wireless communication system according to embodiments of the present disclosure.

As shown in FIG. 4, in step S401, the method 400 performed by a second entity in a wireless communication system according to embodiments of the present disclosure may include: transmitting at least one piece of information of information related to Listen Before Talk (LBT) energy detection threshold, information related to signal strength and/or signal quality, information related to resource status and/or load situation of an unlicensed band and/or a licensed band, information related to LBT failure detection information and/or LBT failure detection result and LBT failure information to a first entity, and/or receiving information including a configuration of conditions for channel busy status checking from the first entity. As described above, in some implementations, the at least one piece of information may be associated with at least one of the second entity and any other entity except the second entity. For example, the information related to Listen Before Talk (LBT) energy detection threshold received from the second entity may be energy detection threshold information of the second entity in an LBT process, or energy detection threshold information of any other entity in an LBT process collected or acquired by the second entity in any way. The other information described above has the same meaning, and will not be repeated here.

Additionally or alternatively, the method 400 may further include receiving first information including LBT energy detection threshold collection and/or reporting configuration from the first entity. In some implementations, the information related to LBT energy detection threshold described above may be acquired and/or transmitted to the first entity by the second entity based on the LBT energy detection threshold collection and/or reporting configuration included in the first information.

Additionally or alternatively, the method 400 may further include transmitting third information to the first entity, which may include information indicating that the second entity cannot transmit information related to LBT energy detection threshold to the first entity based on the first information.

Additionally or alternatively, the method 400 may further include receiving fourth information including signal strength and/or signal quality collection and/or reporting configuration from the first entity. In some implementations, the information related to signal strength and/or signal quality described above may be acquired and/or transmitted to the first entity by the second entity based on the signal strength and/or signal quality collection and/or reporting configuration included in the fourth information.

Additionally or alternatively, the method 400 may further include receiving sixth information including a request for resource status and/or load situation of an unlicensed band and/or a licensed band from the first entity, and transmitting seventh information including a response to the request for resource status and/or load situation of the unlicensed band and/or the licensed band to the first entity. In some implementations, the request for resource status and/or load situation of the unlicensed band and/or the licensed band may be a request for information related to resource status and/or load situation of the unlicensed band and/or the licensed band.

Additionally or alternatively, the method 400 may further include receiving ninth information including a configuration of conditions for channel busy status checking from the first entity.

Additionally or alternatively, the method 400 may further include receiving tenth information including LBT failure detection configuration from the first entity. In some implementations, the information related to LBT failure detection information and/or LBT failure detection result described above may be acquired and/or transmitted to the first entity by the second entity based on the LBT failure detection configuration included in the tenth information.

Additionally or alternatively, the method 400 may further include transmitting twelfth information including an indication that LBT failure information is available to the first entity, and receiving information related to LBT failure information request from the first entity. In some implementations, the information related to LBT failure information request may be transmitted by the first entity to the second entity based on the indication that LBT failure information is available included in the twelfth information.

Various steps of the method 300 and the method 400 according to embodiments of the present disclosure described above may be performed individually or jointly in any combination, and may be performed in any order, for example, simultaneously or in a reverse order of the listed order. In addition, various steps and various information described above will be further described below in combination with specific examples.

Hereinafter, methods performed by a first entity and/or a second entity in a wireless communication system according to embodiments of the present disclosure will be described from various aspects in combination with specific examples. More generally, the methods performed by a first entity and/or a second entity in a wireless communication system according to embodiments of the present disclosure may also be referred to as methods for supporting self-optimization of a wireless communication network.

Example 1

A first aspect of the present disclosure proposes a method for supporting self-optimization of a wireless communication network, which may include that: a first entity transmits first information including LBT Energy Detection (ED) threshold collection and/or reporting configuration to a second entity, so that the second entity may collect energy detection threshold information in an LBT process according to the configuration included in the first information and report the information to the first entity. Therefore, the first entity may acquire the energy detection threshold information of the second entity in the LBT process, and provide reference information for subsequent load information exchange and maximum energy detection threshold updating, so as to provide reference information for load balancing decision and improve the robustness of the LBT transmission mechanism. As described above, in some implementations, the LBT energy detection threshold information may be energy detection threshold information of the second entity in an LBT process, or energy detection threshold information of any other entity in an LBT process collected or acquired by the second entity in any way.

In some implementations, the first information may be included in one or more of the following: new radio report configuration (reportConfigNR) of Radio Resource Control (RRC), event trigger configuration (EventTriggerConfig) and/or periodic report configuration (PeriodicalReportConfig) in reportConfigNR; or an other and/or newly defined RRC and/or Xn and/or X2 and/or F1 and/or E1 and/or NG message.

In some implementations, the first information may include one or more of the following fields or related information:
User equipment identification: used to indicate the identification of a UE for which the LBT energy detection threshold collection and/or reporting is targeted.
Transmitting entity identification: used to indicate the identification of an entity that transmits the first information.
Receiving entity identification: used to indicate the identification of an entity that receives the first information.
Energy detection threshold reporting indication: used to indicate that the energy detection threshold is requested to be reported. The indication may be expressed by a single bit, for example, when the bit is 1, it means that the energy detection threshold needs to be reported, and when the bit is 0, it means that the energy detection threshold does not need to be reported. Alternatively, when the bit is 1, it means that the energy detection threshold does not need to be reported, and when the bit is 0, it means that the energy detection threshold needs to be reported.
Energy detection threshold reporting mode: used to indicate a reporting mode of energy detection threshold. The reporting mode may include periodic type, on-demand type, single reporting type, event triggering type and so on.
Energy detection threshold reporting interval: used to indicate a time interval at which the energy detection threshold needs to be reported.
Energy detection threshold reporting time: used to indicate a time point and/or time period when the energy detection threshold needs to be reported. The time may be indicated by one or more of the following: timer, time point, time period, start time, end time, combination of time point and time period, etc.
Energy detection threshold collection interval: used to indicate a time interval at which the energy detection threshold needs to be collected.
Energy detection threshold collection time: used to indicate a time point and/or time period when the energy detection threshold needs to be collected. The time may be indicated by one or more of the following: timer, time point, time period, start time, end time, combination of time point and time period, etc.
Energy detection threshold measuring interval: used to indicate a time interval at which the energy detection threshold needs to be measured.
Energy detection threshold measuring time: used to indicate a time point and/or time period when the energy detection threshold needs to be measured. The time may be indicated by one or more of the following: timer, time point, time period, start time, end time, combination of time point and time period, etc.
Energy detection threshold reporting start indication: used to indicate the start of energy detection threshold reporting. The indication may be expressed by a single bit, when the bit is 1, it means that energy detection threshold reporting is started, and when the bit is 0, it means that energy detection threshold reporting is not needed and/or energy detection threshold reporting is ended. Alternatively, when the bit is 0, it means that energy detection threshold reporting is started, and when the bit is 1, it means that energy detection threshold reporting is not needed and/or energy detection threshold reporting is ended.
Energy detection threshold reporting end and/or stop indication: used to indicate the end and/or stop of energy detection threshold reporting. The indication may be expressed by a single bit, when the bit is 1, it means that energy detection threshold reporting is ended and/or stopped, and when the bit is 0, it means that energy detection threshold reporting needs to be continued and/or energy detection threshold reporting is started. Alternatively, when the bit is 0, it means that energy detection threshold reporting is ended and/or stopped, and when the bit is 1, it means that energy detection threshold reporting needs to be continued and/or energy detection threshold reporting is started.
Energy detection threshold reporting trigger event: used to indicate an event that may trigger energy detection threshold reporting. The event may be that the maximum energy detection threshold configuration is updated, the energy detection threshold is changed, a difference between the energy detection threshold and a previous energy detection threshold is greater than and/or greater than or equal to and/or less than and/or less than or equal to a threshold, a difference between the energy detection threshold and a specific energy detection threshold is greater than and/or greater than or equal to and/or less than and/or less than or equal to a threshold, and a difference between the energy detection threshold and the maximum energy detection threshold is greater than and/or greater than or equal to and/or less than and/or less than or equal to a threshold and so on. This field may include one or more of the following:
Threshold, such as one or more of the various thresholds described above.
Trigger time: indicates the time when a specific condition of the trigger event is satisfied, to trigger a measurement report.
Maximum energy detection threshold reporting indication: used to indicate that the maximum energy detection threshold needs to be reported. The indication may be expressed by a single bit, for example, when the bit is 1, it means that the maximum energy detection threshold needs to be reported, and when the bit is 0, it means that the maximum energy detection threshold does not need to be reported. Alternatively, when the bit is 1, it means that the maximum energy detection threshold does not need to be reported, and when the bit is 0, the maximum energy detection threshold needs to be reported.
Maximum energy detection threshold reporting mode: used to indicate a reporting mode of maximum energy detection. The reporting mode may include periodic type, on-demand type, single reporting type, event triggering type and so on.
Maximum energy detection threshold reporting interval: used to indicate a time interval at which the maximum energy detection threshold needs to be reported.
Maximum energy detection threshold reporting time: used to indicate a time point and/or time period when the maximum energy detection threshold needs to be reported. The time may be indicated by one or more of the following: timer, time point, time period, start time, end time, combination of time point and time period, etc.
Maximum energy detection threshold collection interval: used to indicate a time interval at which the maximum energy detection threshold needs to be collected.
Maximum energy detection threshold collection time: used to indicate a time point and/or time period when the maximum energy detection threshold needs to be collected. The time may be indicated by one or more of the following: timer, time point, time period, start time, end time, combination of time point and time period, etc.
Maximum energy detection threshold measuring interval: used to indicate a time interval at which the maximum energy detection threshold needs to be measured.
Maximum energy detection threshold measuring time: used to indicate a time point and/or time period when the maximum energy detection threshold needs to be measured. The time may be indicated by one or more of the following: timer, time point, time period, start time, end time, combination of time point and time period, etc.
Maximum energy detection threshold reporting start indication: used to indicate the start of maximum energy detection threshold reporting. The indication may be expressed by a single bit, when the bit is 1, it means that maximum energy detection threshold reporting is started, and when the bit is 0, it means that maximum energy detection threshold reporting is not needed and/or maximum energy detection threshold reporting is ended. Alternatively, when the bit is 0, it means that maximum energy detection threshold reporting is started, and when the bit is 1, it means that maximum energy detection threshold reporting is not needed and/or maximum energy detection threshold reporting is ended.
Maximum energy detection threshold reporting end indication: used to indicate the end of maximum energy detection threshold reporting. The indication may be expressed by a single bit, when the bit is 1, it means that that maximum energy detection threshold reporting is stopped, and when the bit is 0, it means that maximum energy detection threshold reporting needs to be continued and/or maximum energy detection threshold reporting is started. Alternatively, when the bit is 0, it means that maximum energy detection threshold reporting is stopped, and when the bit is 1, it means that maximum energy detection threshold reporting needs to be continued and/or maximum energy detection threshold reporting is started.
Maximum energy detection threshold reporting trigger event: used to indicate an event that may trigger maximum energy detection threshold reporting. The event may be that the maximum energy detection threshold is changed, a difference between the maximum energy detection threshold and a previous maximum energy detection threshold is greater than and/or greater than or equal to and/or less than and/or less than or equal to a threshold, and a difference between the maximum energy detection threshold and a specific energy detection threshold is greater than and/or greater than or equal to and/or less than and/or less than or equal to a threshold. This field may include one or more of the following:
Threshold, such as one or more of the various thresholds described above.
Trigger time: indicates the time when a specific condition of the trigger event is satisfied, to trigger a measurement report.

In some implementations, the second entity may transmit second information including the LBT Energy Detection (ED) threshold result to the first entity according to its own situation and/or the received first information, so that the first entity may acquire the energy detection threshold information of the second entity in the LBT process, and provide reference information for subsequent load information exchange, maximum energy detection threshold updating, etc., so as to provide reference information for load balancing decision and improve the robustness of the LBT transmission mechanism.

In some implementations, the second information may be included in one or more of the following: measurement result (MeasResults), measurement report (MeasurementReport) of RRC; or an other and/or newly defined RRC and/or Xn and/or X2 and/or F1 and/or E1 and/or NG message.

In some implementations, the second information may include one or more of the following fields or related information:
User equipment identification: used to indicate the identification of a UE corresponding to the reported LBT energy detection threshold result.
Transmitting entity identification: used to indicate the identification of an entity that transmits the second information.
Receiving entity identification: used to indicate the identification of an entity that receives the second information.
Energy detection threshold: used to represent a value of the reported energy detection threshold. This value may be an actual collection value or an average value over a period of time.
Reporting mode for the (or current) energy detection threshold: used to indicate a reporting mode used for the energy detection threshold. The reporting mode may include periodic type, on-demand type, single reporting type, event triggering type and so on.
Collection time for the energy detection threshold: used to indicate the collection time point and/or collection time interval corresponding to the reported energy detection threshold.
Event triggering the energy detection threshold reporting: used to indicate an event that triggers the energy detection threshold reporting. The event may be that the maximum energy detection threshold is configured, the energy detection threshold is changed, a difference between the energy detection threshold and a previous energy detection threshold is greater than and/or greater than or equal to and/or less than and/or less than or equal to a threshold, a difference between the energy detection threshold and a specific energy detection threshold is greater than and/or greater than or equal to and/or less than and/or less than or equal to a threshold, and a difference between the energy detection threshold and the maximum energy detection threshold is greater than and/or greater than or equal to and/or less than and/or less than or equal to a threshold. This field may include one or more of the following:
Threshold, such as one or more of the various thresholds described above.
Trigger time: indicates the time when a specific condition of the trigger event is satisfied, to trigger a measurement report.
Maximum energy detection threshold: used to represent a value of the reported maximum energy detection threshold. This value may be an actual collection value or an average value over a period of time.
Reporting mode for the maximum energy detection threshold: used to indicate a reporting mode used for the maximum energy detection threshold. The reporting mode may include periodic type, on-demand type, single reporting type, event triggering type and so on.
Collection time for the maximum energy detection threshold: used to indicate the collection time point and/or collection time interval corresponding to the reported maximum energy detection threshold.
Event triggering the maximum energy detection threshold reporting: used to indicate an event that triggers the maximum energy detection threshold reporting. The event may be that the maximum energy detection threshold is changed, a difference between the maximum energy detection threshold and a previous maximum energy detection threshold is greater than and/or greater than or equal to and/or less than and/or less than or equal to a threshold, and a difference between the maximum energy detection threshold and a specific energy detection threshold is greater than and/or greater than or equal to and/or less than and/or less than or equal to a threshold. This field may include one or more of the following:
Threshold, such as one or more of the various thresholds described above.
Trigger time: indicates the time when a specific condition of the trigger event is satisfied, to trigger a measurement report.

In some implementations, if the second entity cannot transmit the second information including the LBT Energy Detection (ED) threshold result to the first entity according to the received first information, the second entity may transmit third information including that the energy detection threshold result cannot be reported to the first entity, so that the first entity can know that the second entity cannot report according to the configuration, thus avoiding unnecessary waiting.

In some implementations, the third information may be included in one or more of the following: measurement result (MeasResults), measurement report (MeasurementReport) of RRC; or an other and/or newly defined RRC and/or Xn and/or X2 and/or F1 and/or E1 and/or NG message.

In some implementations, the third information may include one or more of the following fields or related information:
User equipment identification: used to indicate the identification of a UE that cannot report its energy detection threshold result.
Transmitting entity identification: used to indicate the identification of an entity that transmits the third information.
Receiving entity identification: used to indicate the identification of an entity that receives the third information.
Indication for that energy detection threshold cannot be reported: used to indicate that the energy detection threshold cannot be reported according to the configuration.
Indication for that maximum energy detection threshold cannot be reported: used to indicate that the maximum energy detection threshold cannot be reported according to the configuration.
Cause: used to indicate the cause why the energy detection threshold and/or the maximum energy detection threshold cannot be reported. The cause may include one or more of the following: there is no energy detection threshold, there is no maximum energy detection threshold, there is no unlicensed band access capability, there is no unlicensed band resources available, there is no LBT process, energy detection threshold cannot be collected, and maximum energy detection threshold cannot be collected.

### Example 2

A second aspect of the present disclosure proposes a method for supporting self-optimization of a wireless communication network, which may include that: a first entity transmits fourth information including signal strength and/or signal quality collection and/or reporting configuration to a second entity, so that the second entity may collect and/or report related information of signal strength and/or signal quality according to the configuration included in the fourth information, and the first entity may acquire related information of signal strength and/or signal quality collected by the second entity so as to provide reference information for the first entity to perform resource configuration. The signal strength and/or signal quality may be a Received Signal Strength Indicator (RSSI), a Reference Signal Receiving Power (RSRP), a Reference Signal Receiving Quality (RSRQ), a Signal to Interference plus Noise Ratio (SINR), etc.

In some implementations, the fourth information may be included in one or more of the following: measurement RSSI-report configuration (MeasRSSI-ReportConfig), new radio report configuration (reportConfigNR), event trigger configuration (EventTriggerConfig) in reportConfigNR and/or periodic report configuration (PeriodicalReportConfig) of RRC; or an other and/or newly defined RRC and/or Xn and/or X2 and/or F1 and/or E1 and/or NG message.

In some implementations, the fourth information may include one or more of the following fields or related information:
User equipment identification: used to indicate the identification of a UE for which the signal strength and/or signal quality collection and/or reporting is targeted.
transmitting entity identification: used to indicate the identification of an entity that transmits the fourth information.
Receiving entity identification: used to indicate the identification of an entity that receives the fourth information.
Channel occupancy threshold: indicates the threshold of signal strength and/or signal quality for channel occupancy evaluation.
Number of collected samples: indicates the number of collected samples of signal strength and/or signal quality required for channel occupancy evaluation.
Maximum number of collected samples: indicates the maximum number of collected samples of signal strength and/or signal quality required for channel occupancy evaluation. The (actual) number of collected samples may be less than and/or less than or equal to the maximum number of collected samples.
Minimum number of collected samples: indicates the minimum number of collected samples of signal strength and/or signal quality required for channel occupancy evaluation. The (actual) number of collected samples may be greater than and/or greater than or equal to the minimum number of collected samples.
Sample collection time interval: indicates the time interval for collecting samples of signal strength and/or signal quality required for channel occupancy evaluation.
Maximum sample collection time interval: indicates the maximum time interval for collecting samples of signal strength and/or signal quality required for channel occupancy evaluation. The (actual) time interval for collection may be less than and/or less than or equal to the maximum sample collection time interval.
Minimum sample collection time interval: indicates the minimum time interval for collecting samples of signal strength and/or signal quality required for channel occupancy evaluation. The (actual) time interval for collection may be greater than and/or greater than or equal to the minimum sample collection time interval.

In some implementations, the second entity may transmit fifth information including signal strength and/or signal quality to the first entity according to its own situation and/or the received fourth information, so as to provide reference information for the first entity to perform resource configuration. The signal strength and/or signal quality may be a Received Signal Strength Indicator (RSSI), a Reference Signal Receiving Power (RSRP), a Reference Signal Receiving Quality (RSRQ), a Signal to Interference plus Noise Ratio (SINR), etc.

In some implementations, the fifth information may be included in one or more of the following: measurement result (MeasResults), measurement report (MeasurementReport) of RRC; or an other and/or newly defined RRC and/or Xn and/or X2 and/or F1 and/or E1 and/or NG message.

In some implementations, the fifth information may include one or more of the following fields or related information:
User equipment identification: used to indicate the identification of a UE corresponding to the reported signal strength and/or signal quality.
transmitting entity identification: used to indicate the identification of an entity that transmits the fifth information.
Receiving entity identification: used to indicate the identification of an entity that receives the fifth information.
Used channel occupancy threshold: indicates the channel occupancy threshold used for the channel occupancy evaluation, for example, signal strength and/or signal quality threshold.
Used number of collected samples: indicates the number of collected samples of signal strength and/or signal quality collected for the channel occupancy evaluation.
Maximum number of collected samples: indicates the maximum number of collected samples of signal strength and/or signal quality for channel occupancy evaluation. The (actual) number of collected samples may be less than and/or less than or equal to the maximum number of collected samples.
Minimum number of collected samples: indicates the minimum number of collected samples of signal strength and/or signal quality for channel occupancy evaluation. The (actual) number of collected samples may be greater than and/or greater than or equal to the minimum number of collected samples.
Used sample collection time interval: indicates the time interval for collecting samples of signal strength and/or signal quality used for the channel occupancy evaluation.
Maximum sample collection time interval: indicates the maximum time interval for collecting samples of signal strength and/or signal quality for channel occupancy evaluation. The (actual) time interval for collection may be less than and/or less than or equal to the maximum sample collection time interval.
Minimum sample collection time interval: indicates the minimum time interval for collecting samples of signal strength and/or signal quality for channel occupancy evaluation. The (actual) time interval for collection may be greater than and/or greater than or equal to the minimum sample collection time interval.
Signal strength and/or signal quality: used to indicate a numerical value of signal strength and/or signal quality. The signal strength and/or signal quality may be a Received Signal Strength Indicator (RSSI), a Reference Signal Receiving Power (RSRP), a Reference Signal Receiving Quality (RSRQ), a Signal to Interference plus Noise Ratio (SINR), etc.
Channel Occupancy (CO) time percentage: used to indicate a percentage of signal strength and/or signal quality greater than and/or greater than or equal to a threshold, and/or a percentage of signal strength and/or signal quality less than and/or less than or equal to a threshold. The threshold may be a channel occupancy threshold.
Cause for report failure: collection failure, insufficient number of samples, etc.

### Example 3

A third aspect of the present disclosure proposes a method for supporting self-optimization of a wireless communication network, which may include that: a first entity transmits sixth information including a request for resource status and/or load situation of an unlicensed band and/or a licensed band to a second entity, so as to inform the second entity that information of the resource status and/or load situation of the unlicensed band and/or the licensed band needs to be fed back to the first entity, so that the first entity may acquire the resource status and/or load situation of the un-licensed band and/or the licensed band of the second entity and/or other entities, so as to provide reference information for the first entity to make self-optimization decision. Herein, the reporting of data volume may be used for data collection for data volume prediction and/or traffic prediction, for example, collection of training data, collection of prediction data, and/or collection of feedback data, etc. The feedback data may be used for evaluation of performance, for example, evaluation of prediction accuracy and/or confidence, and for determining whether a model continues to be applicable, etc. For example, it may be that when the accuracy of prediction is lower than a threshold, a model does not meet conditions for continuing to be applied, and nodes and/or entities will update the model.

In some implementations, the sixth information may be included in one or more of the following: a RESOURCE STATUS REQUEST message of X2 or Xn or F1 or E1; or an EN-DC RESOURCE STATUS REQUEST message of X2; or an other and/or newly defined RRC and/or Xn and/or X2 and/or F1 and/or E1 and/or NG message.

In some implementations, the sixth information may include one or more of the following fields or related information:
User equipment identification: used to indicate the identification and/or identification list of the UE involved in the request for resource status and/or load situation of the unlicensed band and/or the licensed band.
Transmitting entity identification: used to indicate the identification of an entity that transmits the sixth information.
Receiving entity identification: used to indicate the identification of an entity that receives the sixth information.
Signal strength and/or signal quality reporting request: used to indicate that information of signal strength and/or signal quality is requested to be reported. The signal strength and/or signal quality may be a Received Signal Strength Indicator (RSSI), a Reference Signal Receiving Power (RSRP), a Reference Signal Receiving Quality (RSRQ), a Signal to Interference plus Noise Ratio (SINR), etc.
Channel occupancy threshold: indicates the threshold of signal strength and/or signal quality for channel occupancy evaluation.
Number of collected samples: indicates the number of collected samples of signal strength and/or signal quality required for channel occupancy evaluation.
Maximum number of collected samples: indicates the maximum number of collected samples of signal strength and/or signal quality required for channel occupancy evaluation. The (actual) number of collected samples may be less than and/or less than or equal to the maximum number of collected samples.
Minimum number of collected samples: indicates the minimum number of collected samples of signal strength and/or signal quality required for channel occupancy evaluation. The (actual) number of collected samples may be greater than and/or greater than or equal to the minimum number of collected samples.
Sample collection time interval: indicates the time interval for collecting samples of signal strength and/or signal quality required for channel occupancy evaluation.
Maximum sample collection time interval: indicates the maximum time interval for collecting samples of signal strength and/or signal quality required for channel occupancy evaluation. The (actual) time interval for collection may be less than and/or less than or equal to the maximum sample collection time interval.
Minimum sample collection time interval: indicates the minimum time interval for collecting samples of signal strength and/or signal quality required for channel occupancy evaluation. The (actual) time interval for collection may be greater than and/or greater than or equal to the minimum sample collection time interval.
Service resource status and/or load reporting request: used to indicate a reporting request of resource status and/or load information of a single and/or multiple services, where the services may be service types, Quality of Service (QOS), scenarios, etc. Herein the service types may include one or more of the following: voice service, video service, virtual reality service, augmented reality service, call service, etc. The quality of service may include one or more of the following: delay, throughput, confidence, packet loss rate, data rate, etc., which may be identified by a 5G QoS Identifier (5QI), QoS Class Identifier (QCI), etc. The scenarios may include one or more of the following: Ultra-reliable and Low Latency Communications (URLLC), Enhanced Mobile Broadband (eMBB), Massive Machine Type Communication (mMTC), etc.
Service indication: used to indicate the type of a service to be reported, which may be a single service or multiple services (such as a service list). Herein the services may be service types, Quality of Service (QOS), scenarios, etc. Herein the service types may include one or more of the following: voice service, video service, virtual reality service, augmented reality service, call service, etc. The quality of service may include one or more of the following: delay, throughput, confidence, packet loss rate, data rate, etc., which may be identified by a 5G QoS Identifier (5QI), QoS Class Identifier (QCI), etc. The scenarios may include one or more of the following: Ultra-reliable and Low Latency Communications (URLLC), Enhanced Mobile Broadband (eMBB), Massive Machine Type Communication (mMTC), etc.
Scope for requested reporting: used to indicate a scope requested for reporting, where the scope may be identifications and/or identification lists of one or more of the following: node, UE, cell, slice, beam, service, channel, Protocol Data Unit Session, Data Radio Bearers (DRB), QoS flow, QoS level and so on. A cell may be identified by one or more cell identifications. A slice may be identified by one or more Single Network Slice Selection Assistance Information (S-NSSAI). Herein the services may be service types, Quality of Service (QOS), scenarios, etc. Herein the service types may include one or more of the following: voice service, video service, virtual reality service, augmented reality service, call service, etc. The quality of service may include one or more of the following: delay, throughput, confidence, packet loss rate, data rate, etc., which may be identified by a 5G QOS Identifier (5QI), QoS Class Identifier (QCI), etc. The scenarios may include one or more of the following: Ultra-reliable and Low Latency Communications (URLLC), Enhanced Mobile Broadband (eMBB), Massive Machine Type Communication (mMTC), etc. A channel may be identified by a channel identification.
Data volume reporting request: used to indicate that information of data volume is requested to be reported.
Time information corresponding to data volume reporting: used to indicate the time information of data volume reporting. This information may be one or more of the following: reporting time point, reporting time interval, reporting time period, etc. A time interval may be expressed by a timer, a combination of a start time and an end time, and a combination of a start time and a time interval, etc.
Time information corresponding to data volume measurement: used to indicate the time information of data volume measurement. This information may be one or more of the following: measurement time point, measurement time interval, measurement time period, etc. A time interval may be expressed by a timer, a combination of a start time and an end time, and a combination of a start time and a time interval, etc.
Measurement time information of reporting content: used to indicate the measurement time information of parameters that needs to be reported. This information may be one or more of the following: measurement time point, measurement time interval, measurement time period, etc. A time interval may be expressed by a timer, a combination of a start time and an end time, and a combination of a start time and a time interval, etc.
Reporting content: used to indicate parameters that need to be reported. Reporting Prediction parameters include one or more of the following: Transport Network Layer (TNL) capacity indicator, radio resource status, composite available capacity group, composite available resource group, number of active UEs, number of Radio Resource Control (RRC) connections, slice available capacity, hardware (HW) capacity indicator, S1 TNL load indicator, hardware (HW) load indicator, Almost Blank Subframe (ABS) status, Reference Signal Received Power (RSRP) measurement report list, Reference Signal Receiving Quality (RSRQ) measurement report, Signal to Interference plus Noise Ratio (SINR) measurement report, Channel State Information (CSI) report, cell reporting indicator, Channel Occupancy time percentage, Energy Detection threshold, signal strength and/or signal quality, channel busy percentage, data volume, and Jitter of various content parameters, etc. Herein the jitter may be a variance or standard deviation of a parameter. The above parameters may be one's own instances, instances of a neighboring cell, instances of other coexistence technologies (for example, Wireless Local Area Network (WLAN), Bluetooth, etc.), a sum of their own instance and an instance of a neighboring cell, or an average of one's own instance and an instance of a neighboring cell. The above parameters may be instances for uplink, instances for downlink, and instances for uplink and downlink.

In some implementations, the sixth information may also include prediction information of resource status and/or load situation. More specifically, the sixth information may also include one or more of the following fields or related information:
Prediction user equipment identification: used to indicate the identification of a UE involved in resource status and/or load situation prediction.
Unlicensed band prediction identification: used to indicate a request for prediction of resource status and/or load situation of an unlicensed band.
Prediction registration request: used to indicate the start, end and addition of prediction.
Time interval for requested prediction: used to indicate a time point and/or time interval for prediction. The time may be a relative time or an absolute time. A time interval may be expressed by a timer, a combination of a start time and an end time, and a combination of a start time and a time interval, etc. If it is a time interval, it may be represented by 2*n bits, for example, the first n bits represent a prediction start time and the last n bits represent a prediction end time. It may also be represented by separate fields, including one or more of the following:
Prediction start time: used to indicate a start time of the prediction. The start time may be a relative time or an absolute time.
Prediction end time: used to indicate an end time of the prediction. The end time may be a relative time or an absolute time.
Applicable (or validity) time for requested prediction content: used to indicate the prediction time point and/or prediction time interval corresponding to the prediction content. The time may be a relative time or an absolute time. A time interval may be expressed by a timer, a combination of a start time and an end time, and a combination of a start time and a time interval, etc. If it is a time interval, it may be represented by 2*n bits, for example, the first n bits represent the start time and the last n bits represent the end time. It may also be represented by separate fields, including one or more of the following:
Start time: used to indicate the start time of the applicable (or validity) time. The start time may be a relative time or an absolute time.
End time: used to indicate the end time of the applicable (or validity) time. The end time may be a relative time or an absolute time.
scope for requested prediction: used to indicate a scope requested for prediction, where the scope may be identifications and/or identification lists of one or more of the following: node, UE, cell, slice, beam, service, channel, Protocol Data Unit Session, Data Radio Bearers (DRB), QoS flow, QoS level and so on. A cell may be identified by one or more cell identifications. A slice may be identified by one or more Single Network Slice Selection Assistance Information (S-NSSAI). Herein the services may be service types, Quality of Service (QOS), scenarios, etc. Herein the service types may include one or more of the following: voice service, video service, virtual reality service, augmented reality service, call service, etc. The quality of service may include one or more of the following: delay, throughput, confidence, packet loss rate, data rate, etc., which may be identified by a 5G QoS Identifier (5QI), QoS Class Identifier (QCI), etc. The scenarios may include one or more of the following: Ultra-reliable and Low Latency Communications (URLLC), Enhanced Mobile Broadband (eMBB), Massive Machine Type Communication (mMTC), etc. A channel may be identified by a channel identification.
Prediction content: used to indicate parameters that need to be predicted. Prediction parameters include one or more of the following: Transport Network Layer (TNL) capacity indicator, radio resource status, composite available capacity group, composite available resource group, number of active UEs, number of Radio Resource Control (RRC) connections, slice available capacity, hardware (HW) capacity indicator, S1 TNL load indicator, hardware (HW) load indicator, Almost Blank Subframe (ABS) status, Reference Signal Received Power (RSRP) measurement report list, Reference Signal Receiving Quality (RSRQ) measurement report, Signal to Interference plus Noise Ratio (SINR) measurement report, Channel State Information (CSI) report, cell reporting indicator, Channel Occupancy time percentage, Energy Detection threshold, signal strength and/or signal quality, channel busy percentage, data volume, and Jitter of various content parameters, etc. Herein the jitter may be a variance or standard deviation of a parameter. The above parameters may be one's own instances, instances of a neighboring cell, instances of other coexistence technologies (for example, Wireless Local Area Network (WLAN), Bluetooth, etc.), a sum of their own instance and an instance of a neighboring cell, or an average of one's own instance and an instance of a neighboring cell. The above parameters may be instances for uplink, instances for downlink, and instances for uplink and downlink.
Prediction reporting period: used to indicate an interval for periodic reporting of prediction content. The reporting period may also be the prediction time of the reported data. If there is no content in this field, it means that a single report is suitable, and the prediction time of a single report is from the prediction start time to the prediction end time.
Indication of that accuracy of result and/or prediction model needs to be reported: indicates an indication that the accuracy of prediction results and/or prediction models need to be reported. Herein the accuracy may be accuracy, confidence and so on.
Identification of support of partial reporting: used to indicate whether to allow reporting part of the requested content. This field may be represented by a single bit, for example, when the bit is 1, it means that partial reporting is allowed, and when the bit is 0, it means that partial reporting is not allowed; alternatively, when the bit is 0, it means that partial reporting is allowed, and when the bit is 1, it means that partial reporting is not allowed. This identification may be with respect for one or more of the following: measurement results and/or contents, prediction results and/or contents, non-prediction results and/or contents, etc.
Indication of reporting necessity: used to indicate the reporting necessity of the content and/or prediction content requested to be reported, for example, it may indicate whether this part of content must be reported. The indication may include one or more of the following: must report, may report, need to report, etc. The degree of necessity may be represented by numbers. The indication may be aimed at the whole content and/or prediction content requested to be reported, or may be aimed at one or more specific reporting parameters and/or predicted parameters among them. The necessity may also be importance. The reporting necessity may also be the importance of the content.
Condition and/or event for triggering reporting: when a reporting condition and/or event is satisfied, reporting is triggered. The reporting condition and/or event may be that a parameter and/or prediction parameter is greater than and/or greater than or equal to and/or less than and/or less than or equal to a certain threshold, or that the prediction accuracy and/or confidence is greater than and/or greater than or equal to and/or less than and/or less than or equal to a certain threshold. The parameter and/or prediction parameter may be a parameter in the reporting content and/or the prediction content. The reporting may be reporting of a prediction content or reporting of a non-prediction content. The non-prediction content may be the above-mentioned reporting content.

In some implementations, the second entity may transmit seventh information including a response to the request for resource status and/or load situation of an unlicensed band and/or a licensed band to the first entity according to the request information included in the sixth information as described above, so as to feed back whether it can be reported to the first entity.

In some implementations, the seventh information may be included in one or more of the following: a RESOURCE STATUS RESPONSE message or a RESOURCE STATUS FAILURE message of X2 or Xn or F1 or E1; or an EN-DC RESOURCE STATUS RESPONSE message or an EN-DC RESOURCE STATUS FAILURE message of X2; or an other and/or newly defined RRC and/or Xn and/or X2 and/or F1 and/or E1 and/or NG message.

In some implementations, the seventh information may include one or more of the following fields or related information:
User equipment identification: used to indicate the identification of a UE involved in the response to the request for resource status and/or load situation of an unlicensed band and/or a licensed band.
Transmitting entity identification: used to indicate the identification of an entity that transmits the seventh information.
Receiving entity identification: used to indicate the identification of an entity that receives the seventh information.
Prediction request confirmation: it may be a single bit to identify whether prediction resource information can be transmitted. For example, 1 indicates that the prediction resource information can be transmitted, and 0 indicates that the prediction resource information cannot be transmitted. Alternatively, 0 indicates that the prediction resource information can be transmitted, and 1 indicates that the prediction resource information cannot be transmitted.
One-by-one prediction request content confirmation: it may be in a form of bitmap, in which each bit corresponds to one prediction content. For example, when the bit is 1, it means that the prediction resource information of the corresponding prediction content can be transmitted, and when the bit is 0, it means that the prediction resource information of the corresponding prediction content cannot be transmitted. It may also be separate fields to indicate different prediction content confirmation.
Reportable content: indicates a content and/or content list that can be reported, where the content may be an actual content or a prediction content, and includes one or more of the following: Transport Network Layer (TNL) capacity indicator, radio resource status, composite available capacity group, composite available resource group, number of active UEs, number of Radio Resource Control (RRC) connections, slice available capacity, hardware (HW) capacity indicator, SI TNL load indicator, hardware (HW) load indicator, Almost Blank Subframe (ABS) status, Reference Signal Received Power (RSRP) measurement report list, Reference Signal Receiving Quality (RSRQ) measurement report, Signal to Interference plus Noise Ratio (SINR) measurement report, Channel State Information (CSI) report, cell reporting indicator, Channel Occupancy time percentage, Energy Detection threshold, signal strength and/or signal quality, channel busy percentage, data volume, and Jitter of various content parameters, etc. Herein the jitter may be a variance or standard deviation of a parameter. The above parameters may be one's own instances, instances of a neighboring cell, instances of other coexistence technologies (for example, WLAN, Bluetooth, etc.), a sum of their own instance and an instance of a neighboring cell, or an average of one's own instance and an instance of a neighboring cell. The above parameters may be instances for uplink, instances for downlink, and instances for uplink and downlink. The content may also be indicated by one bit whether it can be reported in full. For example, when the bit is 1, it means that it can be reported in full, and when the bit is 0, it means that it can be reported partially and/or cannot be reported at all. The content may also be indicated by one bit whether it can be reported. For example, when the bit is 1, it means that it cannot be reported at all, and when the bit is 0, it means that it can be reported partially and/or in full.
Non-reportable content: indicates a content and/or list that cannot be reported, where the content may be an actual content or a prediction content, and includes one or more of the following: Transport Network Layer (TNL) capacity indicator, radio resource status, composite available capacity group, composite available resource group, number of active UEs, number of Radio Resource Control (RRC) connections, slice available capacity, hardware (HW) capacity indicator, S1 TNL load indicator, hardware (HW) load indicator, Almost Blank Subframe (ABS) status, Reference Signal Received Power (RSRP) measurement report list, Reference Signal Receiving Quality (RSRQ) measurement report, Signal to Interference plus Noise Ratio (SINR) measurement report, Channel State Information (CSI) report, cell reporting indicator, Channel Occupancy time percentage, Energy Detection threshold, signal strength and/or signal quality, channel busy percentage, data volume, and Jitter of various content parameters, etc. Herein the jitter may be a variance or standard deviation of a parameter. The above parameters may be one's own instances, instances of a neighboring cell, instances of other coexistence technologies (for example, WLAN, Bluetooth, etc.), a sum of their own instance and an instance of a neighboring cell, or an average of one's own instance and an instance of a neighboring cell. The above parameters may be instances for uplink, instances for downlink, and instances for uplink and downlink. The content may also be indicated by one bit whether it can be reported in full. For example, when the bit is 1, it means that it can be reported in full, and when the bit is 0, it means that it can be reported partially and/or cannot be reported at all. The content may also be indicated by one bit whether it can be reported. For example, when the bit is 1, it means that it cannot be reported at all, and when the bit is 0, it means that it can be reported partially and/or in full.
Reportable content scope: used to indicate a scope of reportable contents, where the scope may be identifications and/or identification lists of one or more of the following: node, UE, cell, slice, beam, service, channel, Protocol Data Unit Session, Data Radio Bearers (DRB), QoS flow, QoS level and so on. A cell may be identified by one or more cell identifications. A slice may be identified by one or more Single Network Slice Selection Assistance Information (S-NSSAI). Herein the services may be service types, Quality of Service (QOS), scenarios, etc. Herein the service types may include one or more of the following: voice service, video service, virtual reality service, augmented reality service, call service, etc. The quality of service may include one or more of the following: delay, throughput, confidence, packet loss rate, data rate, etc., which may be identified by a 5G QoS Identifier (5QI), QoS Class Identifier (QCI), etc. The scenarios may include one or more of the following: Ultra-reliable and Low Latency Communications (URLLC), Enhanced Mobile Broadband (eMBB), Massive Machine Type Communication (mMTC), etc. A channel may be identified by a channel identification. The content may also be indicated by one bit whether it can be reported in full. For example, when the bit is 1, it means that it can be reported in full, and when the bit is 0, it means that it can be reported partially and/or cannot be reported at all. The content may also be indicated by one bit whether it can be reported. For example, when the bit is 1, it means that it cannot be reported at all, and when the bit is 0, it means that it can be reported partially and/or in full.
Non-reportable content scope: used to indicate a scope of non-reportable contents, where the scope may be identifications and/or identification lists of one or more of the following: node, UE, cell, slice, beam, service, channel, Protocol Data Unit Session, Data Radio Bearers (DRB), QoS flow, QoS level and so on. A cell may be identified by one or more cell identifications. A slice may be identified by one or more Single Network Slice Selection Assistance Information (S-NSSAI). Herein the services may be service types, Quality of Service (QOS), scenarios, etc. Herein the service types may include one or more of the following: voice service, video service, virtual reality service, augmented reality service, call service, etc. The quality of service may include one or more of the following: delay, throughput, confidence, packet loss rate, data rate, etc., which may be identified by a 5G QOS Identifier (5QI), QoS Class Identifier (QCI), etc. The scenarios may include one or more of the following: Ultra-reliable and Low Latency Communications (URLLC), Enhanced Mobile Broadband (eMBB), Massive Machine Type Communication (mMTC), etc. A channel may be identified by a channel identification. The content may also be indicated by one bit whether it can be reported in full. For example, when the bit is 1, it means that it can be reported in full, and when the bit is 0, it means that it can be reported partially and/or cannot be reported at all. The content may also be indicated by one bit whether it can be reported. For example, when the bit is 1, it means that it cannot be reported at all, and when the bit is 0, it means that it can be reported partially and/or in full.
Cause: used to indicate the reason for request failure, for example, it may include one or more of the following: failure to predict the resource status and/or load situation, failure to predict the resource status and/or load situation of an unlicensed band, no prediction capability of resource status and/or load situation, no prediction capability of resource status and/or load situation of an unlicensed band, no data volume information, no data volume prediction capability, failure to report in full, no prediction capability of requested prediction content, no artificial intelligence and/or machine learning capability, and the prediction confidence and/or accuracy cannot meet a requirement.
Prediction confidence: indicates the confidence and/or accuracy of a prediction result and/or a prediction model.
Request failure indication: used to indicate that the request failed. For example, the indication may be represented by a bit. When the bit is 1, it means that the request failed, and when the bit is 0, it means that the report can be made; or when the bit is 0, it means that the request failed, and when the bit is 1, it means that the report can be made. The request failure may indicate that the request for resource status and/or load situation of an unlicensed band and/or a licensed band failed.

In some implementations, when the identification of support of partial reporting in the sixth information indicates that partial reporting is not supported, when the second entity cannot report all the requested contents, the second entity transmits a message of the seventh information including request failure to the first entity; when the identification of support of partial reporting in the sixth information indicates that partial reporting is supported, when the second entity cannot report all the requested contents, the second entity informs the first entity of reportable contents through the seventh information. This implementation can flexibly solve the problem that the second entity cannot report all the requested contents, and it can report the reportable contents according to the situation according to the indication of the first entity, or transmit the information including request failure, so as to avoid that all the requested contents cannot be reported due to one or more of the requested contents cannot be reported.

In some implementations, when the indication of reporting necessity in the sixth information indicates that the content must be reported, the requested entity (for example, the second entity) must report the content. If it cannot be reported, the requested entity transmits the seventh information including request failure to the requesting entity (for example, the first entity). When the indication of reporting necessity in the sixth information indicates that the content is a content that may be reported, the requested entity can report the content that may be reported to the requesting entity through the seventh information and/or transmit relevant content through eighth information according to its own situation. For example, its own situation may include whether it can perform prediction, whether it has this part of information, etc. This implementation can flexibly solve the problem that the second entity cannot report all the requested contents, so as to avoid that all the requested contents cannot be reported due to one or more of the requested contents cannot be reported. The second entity can also arrange its reported contents reasonably according to the reporting necessity, for example, it can select the content with high necessity to report. In some implementations, for example, if only part of the prediction content requested to be reported can be predicted due to the limitation of computing power, then the second entity can select the content with high necessity to predict and report according to the necessity.

In some implementations, the second entity may transmit eighth information including resource status and/or load situation of an unlicensed band and/or a licensed band to the first entity according to the configuration in the request for resource status and/or load situation of the unlicensed band and/or the licensed band and/or autonomously according to the second entity's own situation (for example, the resource status and/or load situation are too high or too low), so that the first entity may acquire the resource status and/or load situation of the unlicensed band and/or the licensed band of the second entity and/or other entities, so as to provide reference information for the first entity to make self-optimization decision.

In some implementations, the eighth information may be included in one or more of the following: a RESOURCE STATUS UPDATE message of X2 or Xn or F1 or E1; or an EN-DC RESOURCE STATUS UPDATE message of X2; or a gNB-DU STATUS INDICATION message of F1; or a gNB-CU-UP STATUS INDICATION message of E1; or an other and/or newly defined RRC and/or Xn and/or X2 and/or F1 and/or E1 and/or NG message.

In some implementations, the eighth information may include one or more of the following fields or related information:
User equipment identification: used to indicate the identification of a UE involved in the resource status and/or load situation of an unlicensed band and/or a licensed band.
Transmitting entity identification: used to indicate the identification of an entity that transmits the eighth information.
Receiving entity identification: used to indicate the identification of an entity that receives the eighth information.
Signal strength and/or signal quality: used to indicate a numerical value of signal strength and/or signal quality. The signal strength and/or signal quality may be a Received Signal Strength Indicator (RSSI), a Reference Signal Receiving Power (RSRP), a Reference Signal Receiving Quality (RSRQ), a Signal to Interference plus Noise Ratio (SINR), etc.
Used channel occupancy threshold: indicates the channel occupancy threshold used for the channel occupancy evaluation, for example, signal strength and/or signal quality threshold.
Channel busy percentage: used to indicate a percentage of signal strength and/or signal quality greater than and/or greater than or equal to a threshold, and/or a percentage of signal strength and/or signal quality less than and/or less than or equal to a threshold. The threshold may be a channel occupancy threshold. The above parameters may be one's own instances, instances of a neighboring cell, instances of other coexistence technologies (for example, WLAN, Bluetooth, etc.), a sum of their own instance and an instance of a neighboring cell, or an average of one's own instance and an instance of a neighboring cell. The above parameters may be instances for uplink, instances for downlink, and instances for uplink and downlink.
Resource percentage: used to indicate a percentage of monitored and/or used and/or allocated resources to channel resources. The channel resources may be resources of an unlicensed band, for example, a 20 MHz resource chunk.
Maximum energy detection threshold: used to indicate the maximum energy detection threshold used on a specific resource. For example, the specific resource may be one or more channels, or one or more resource chunks, and so on.
Service indication corresponding to reported information: used to indicate the service type corresponding to the reported resource status and/or load information, which may be a single service or multiple services (such as a service list). Herein the services may be service types, Quality of Service (QOS), scenarios, etc. Herein the service types may include one or more of the following: voice service, video service, virtual reality service, augmented reality service, call service, etc. The quality of service may include one or more of the following: delay, throughput, confidence, packet loss rate, data rate, etc., which may be identified by a 5G QoS Identifier (5QI), QoS Class Identifier (QCI), etc. The scenarios may include one or more of the following: Ultra-reliable and Low Latency Communications (URLLC), Enhanced Mobile Broadband (eMBB), Massive Machine Type Communication (mMTC), etc.
Report content: a parameter used to indicate the resource status and/or load situation. This parameter includes one or more of the following: Transport Network Layer (TNL) capacity indicator, radio resource status, composite available capacity group, composite available resource group, number of active UEs, number of Radio Resource Control (RRC) connections, slice available capacity, hardware (HW) capacity indicator, S1 TNL load indicator, hardware (HW) load indicator, Almost Blank Subframe (ABS) status, Reference Signal Received Power (RSRP) measurement report list, Reference Signal Receiving Quality (RSRQ) measurement report, Signal to Interference plus Noise Ratio (SINR) measurement report, Channel State Information (CSI) report, cell reporting indicator, Channel Occupancy time percentage, Energy Detection threshold, signal strength and/or signal quality, channel busy percentage, data volume, and Jitter of various content parameters, etc. Herein the jitter may be a variance or standard deviation of a parameter. The above parameters may be one's own instances, instances of a neighboring cell, instances of other coexistence technologies (for example, WLAN, Bluetooth, etc.), a sum of their own instance and an instance of a neighboring cell, or an average of one's own instance and an instance of a neighboring cell. The above parameters may be instances for uplink, instances for downlink, and instances for uplink and downlink.
Applicable (or validity) time for reporting content: used to indicate the applicable (or validity) time point and/or time interval of the reporting content. The time may be a relative time or an absolute time. A time interval may be expressed by a timer, a combination of a start time and an end time, and a combination of a start time and a time interval, etc. If it is a time interval, it may include a start time and an end time, which may be represented by 2*n bits. For example, the first n bits represent the start time and the last n bits represent the end time. It may also be represented by separate fields, including one or more of the following:
Applicable start time for reporting content: used to indicate the start time applicable for the resource status and/or load information. The start time may be a relative time or an absolute time.
Applicable end time for reporting content: used to indicate the end time applicable for the resource status and/or load information. The end time may be a relative time or an absolute time.
Scope corresponding to reporting content: used to indicate the scope corresponding to the reporting content, where the scope may be identifications and/or identification lists of one or more of the following: node, UE, cell, slice, beam, service, channel, Protocol Data Unit Session, Data Radio Bearers (DRB), QoS flow, QoS level and so on. A cell may be identified by one or more cell identifications. A slice may be identified by one or more Single Network Slice Selection Assistance Information (S-NSSAI). Herein the services may be service types, Quality of Service (QOS), scenarios, etc. Herein the service types may include one or more of the following: voice service, video service, virtual reality service, augmented reality service, call service, etc. The quality of service may include one or more of the following: delay, throughput, confidence, packet loss rate, data rate, etc., which may be identified by a 5G QoS Identifier (5QI), QoS Class Identifier (QCI), etc. The scenarios may include one or more of the following: Ultra-reliable and Low Latency Communications (URLLC), Enhanced Mobile Broadband (eMBB), Massive Machine Type Communication (mMTC), etc. A channel may be identified by a channel identification.
Condition and/or event triggering the reporting: a condition and/or event that triggers the report. The reporting condition and/or event may be that a parameter and/or prediction parameter is greater than and/or greater than or equal to and/or less than and/or less than or equal to a certain threshold, or that the prediction accuracy and/or confidence is greater than and/or greater than or equal to and/or less than and/or less than or equal to a certain threshold. The parameter and/or prediction parameter may be a parameter in the reporting content and/or prediction result. The reporting may be reporting of a prediction content or reporting of a non-prediction content. The non-prediction content may be the above-mentioned reporting content.

In some implementations, the eighth information may include prediction information for resource status and/or load, and may include one or more of the following fields or related information:
Prediction content prediction identification: used to indicate whether the resource status and/or load information is a prediction content. This field may be represented by a single bit, for example, 1 indicates that the information is a prediction content and 0 indicates that the information is an actual status content.
Applicable (or validity) time for prediction content: used to indicate the prediction applicable (or validity) time point and/or time interval of the resource status and/or load information. The time may be a relative time or an absolute time. A time interval may be expressed by a timer, a combination of a start time and an end time, and a combination of a start time and a time interval, etc. If it is a time interval, it may include a start time and an end time, which may be represented by 2*n bits. For example, the first n bits represent the start time and the last n bits represent the end time. It may also be represented by separate fields, including one or more of the following:
Applicable start time for prediction content: used to indicate the start time applicable for the resource status and/or load information. The start time may be a relative time or an absolute time.
Applicable end time for prediction content: used to indicate the end time applicable for the resource status and/or load information. The end time may be a relative time or an absolute time.
Reported information of resource status and/or load: used to indicate information of reported resource status and/or load. The information of resource status and/or load includes one or more of the following: Transport Network Layer (TNL) capacity indicator, radio resource status, composite available capacity group, composite available resource group, number of active UEs, number of Radio Resource Control (RRC) connections, slice available capacity, hardware (HW) capacity indicator, S1 TNL load indicator, hardware (HW) load indicator, Almost Blank Subframe (ABS) status, Reference Signal Received Power (RSRP) measurement report list, Reference Signal Receiving Quality (RSRQ) measurement report, Signal to Interference plus Noise Ratio (SINR) measurement report, Channel State Information (CSI) report, cell reporting indicator, Channel Occupancy time percentage, Energy Detection threshold, signal strength and/or signal quality, channel busy percentage, data volume, and Jitter of various content parameters, etc. Herein the jitter may be a variance or standard deviation of a parameter. The above parameters may be one's own instances, instances of a neighboring cell, instances of other coexistence technologies (for example, WLAN, Bluetooth, etc.), a sum of their own instance and an instance of a neighboring cell, or an average of one's own instance and an instance of a neighboring cell. The above parameters may be instances for uplink, instances for downlink, and instances for uplink and downlink.
Prediction result: used to indicate prediction results of requested prediction parameters. The prediction results include one or more of the following: Transport Network Layer (TNL) capacity indicator, radio resource status, composite available capacity group, composite available resource group, number of active UEs, number of Radio Resource Control (RRC) connections, slice available capacity, hardware (HW) capacity indicator, S1 TNL load indicator, hardware (HW) load indicator, Almost Blank Subframe (ABS) status, Reference Signal Received Power (RSRP) measurement report list, Reference Signal Receiving Quality (RSRQ) measurement report, Signal to Interference plus Noise Ratio (SINR) measurement report, Channel State Information (CSI) report, cell reporting indicator, Channel Occupancy time percentage, Energy Detection threshold, signal strength and/or signal quality, channel busy percentage, data volume, and Jitter of various content parameters, etc. Herein the jitter may be a variance or standard deviation of a parameter. The above parameters may be one's own instances, instances of a neighboring cell, instances of other coexistence technologies (for example, WLAN, Bluetooth, etc.), a sum of their own instance and an instance of a neighboring cell, or an average of one's own instance and an instance of a neighboring cell. The above parameters may be instances for uplink, instances for downlink, and instances for uplink and downlink.
Scope corresponding to prediction result: used to indicate the scope corresponding to the prediction result, where the scope may be identifications and/or identification lists of one or more of the following: node, UE, cell, slice, beam, service, channel, Protocol Data Unit Session, Data Radio Bearers (DRB), QoS flow, QoS level and so on. A cell may be identified by one or more cell identifications. A slice may be identified by one or more Single Network Slice Selection Assistance Information (S-NSSAI). Herein the services may be service types, Quality of Service (QOS), scenarios, etc. Herein the service types may include one or more of the following: voice service, video service, virtual reality service, augmented reality service, call service, etc. The quality of service may include one or more of the following: delay, throughput, confidence, packet loss rate, data rate, etc., which may be identified by a 5G QoS Identifier (5QI), QoS Class Identifier (QCI), etc. The scenarios may include one or more of the following: Ultra-reliable and Low Latency Communications (URLLC), Enhanced Mobile Broadband (eMBB), Massive Machine Type Communication (mMTC), etc. A channel may be identified by a channel identification.
Prediction confidence: indicates the confidence and/or accuracy of a prediction result and/or a prediction model.

### Example 4

A fourth aspect of the present disclosure proposes a method for supporting self-optimization of a wireless communication network, which may include that: a first entity transmits ninth information including a configuration of conditions for channel busy status checking to a second entity, so as to prevent the second entity from switching to a cell in a channel busy status, affecting performance, and to enable the second entity to successfully perform conditional handover, etc.

In some implementations, the ninth information may be included in one or more of the following: CondTriggerConfig, ReportConfigNR, ReportConfig, ReportConfigToAddMod, ReportConfigToAddModList of RRC; or an other and/or newly defined RRC and/or Xn and/or X2 and/or F1 and/or E1 and/or NG message.

In some implementations, the ninth information may include one or more of the following fields or related information:
User equipment identification: used to indicate the identification of a UE involved in the configuration of conditions for channel busy status checking.
Transmitting entity identification: used to indicate the identification of an entity that transmits the ninth information.
Receiving entity identification: used to indicate the identification of an entity that receives the ninth information.
Signal strength and/or signal quality threshold: this threshold is used to determine whether the detected signal strength and/or signal quality satisfies a condition. For example, when the detected signal strength and/or signal quality is greater than and/or greater than or equal to a threshold, or when the detected signal strength and/or signal quality is less than and/or less than or equal to a threshold, it is determined that the condition is satisfied. The threshold may be single or multiple. When there are multiple thresholds, it may be determined that the condition is satisfied when one of the thresholds is satisfied or when the multiple thresholds are satisfied at the same time. In some implementations, for example, it may be a threshold of RSSI, and when a detected RSSI is less than and/or less than or equal to the threshold, subsequent operations may be triggered, for example, conditional handover may be triggered. For example, it may also be that when RSRP and/or RSRQ and/or SINR are greater than and/or greater than or equal to a threshold, and/or when a detected RSSI is less than and/or less than or equal to a threshold, subsequent operations may be triggered, for example, conditional handover may be triggered.
Channel busy percentage threshold: this threshold is used to determine whether the detected channel busy percentage satisfies a condition. For example, when the detected channel busy percentage is greater than and/or greater than or equal to a threshold, or when the detected channel busy percentage is less than and/or less than or equal to a threshold, it is determined that the condition is satisfied. The threshold may be single or multiple. When there are multiple thresholds, it may be determined that the condition is satisfied when one of the thresholds is satisfied or when the multiple thresholds are satisfied at the same time. In some implementations, for example, it may be that the percentage of RSSI greater than a predetermined threshold is the channel busy percentage, and when the detected channel busy percentage is less than and/or less than or equal to the threshold, subsequent operations may be triggered, for example, conditional handover may be triggered. For example, it may also be that when RSRP and/or RSRQ and/or SINR are greater than and/or greater than or equal to a threshold, and/or when the percentage of RSSI greater than a predetermined threshold is the channel busy percentage and the detected channel busy percentage is less than and/or less than or equal to the threshold, subsequent operations may be triggered, for example, conditional handover may be triggered.

### Example 5

A fifth aspect of the present disclosure proposes a method for supporting self-optimization of a wireless communication network, which may include that: a first entity transmits tenth information including LBT failure detection configuration to a second entity, so that the second entity can detect whether LBT failure occurs according to the configuration, so that the first entity may acquire an LBT failure detection result, and the first entity can make optimization decisions, such as resource configuration updating, mobility optimization (e.g., handover), and the like.

In some implementations, the tenth information may be included in one or more of the following: a UE CONTEXT MODIFICATION REQUEST message, a gNB-CU CONFIGURATION UPDATE message of F1; or an other and/or newly defined RRC and/or Xn and/or X2 and/or F1 and/or E1 and/or NG message.

In some implementations, the tenth information may include one or more of the following fields or related information:
User equipment identification
transmitting entity identification: used to indicate the identification of an entity that transmits the tenth information.
Receiving entity identification: used to indicate the identification of an entity that receives the tenth information.
LBT failure detection timer: a timer used for continuous LBT failure detection. For example, during the running time of the timer, it is detected whether continuous LBT failure occurs. The timer may be for uplink, downlink, uplink and downlink, uplink or downlink, etc.
Maximum count of LBT failure instances: used to determine the number of LBT failures, which when reached, a subsequent process is activated, such as LBT failure recovery, LBT failure reporting, resource configuration updating, mobility optimization (e.g. handover), etc. The maximum count may be for uplink, downlink, uplink and downlink, uplink or downlink, etc.

In some implementations, the second entity may transmit eleventh information including LBT failure detection information and/or LBT failure detection results to the first entity according to its own situation (e.g., autonomously) and/or according to LBT failure detection configuration information, so that the first entity may acquire LBT failure detection information and/or results, and the first entity can make optimization decisions, such as resource configuration updating, mobility optimization (e.g., handover), etc.

In some implementations, the eleventh information may be included in one or more of the following: a UE CONTEXT MODIFICATION RESPONSE message, a UE CONTEXT MODIFICATION REQUIRED message, and a gNB-DU CONFIGURATION UPDATE message of F1; or an other and/or newly defined RRC and/or Xn and/or X2 and/or F1 and/or E1 and/or NG message.

In some implementations, the eleventh information may include one or more of the following fields or related information:
User equipment identification: used to indicate the identification of a UE corresponding to the reported LBT failure detection information and/or LBT failure detection result.
Transmitting entity identification: used to indicate the identification of an entity that transmits the eleventh information.
Receiving entity identification: used to indicate the identification of an entity that receives the eleventh information.
Serving cell identification: used to indicate the identification of the serving cell corresponding to the reported LBT failure detection information and/or LBT failure detection result.
Channel identification: used to indicate the identification of the channel corresponding to the reported LBT failure detection information and/or LBT failure detection result.
LBT failure detection timer: a timer used for continuous LBT failure detection. For example, during the running time of the timer, it is detected whether continuous LBT failure occurs. The timer may be for uplink, downlink, uplink and downlink, uplink or downlink, etc.
Maximum count of LBT failure instances: used to determine the number of LBT failures, which when reached, a subsequent process is activated, such as LBT failure recovery, LBT failure reporting, resource configuration updating, mobility optimization (e.g. handover), etc. The maximum count may be for uplink, downlink, uplink and downlink, uplink or downlink, etc.
Downlink LBT failure indication: used to indicate the occurrence of downlink LBT failure. It may be represented by a single bit. For example, when the bit is 1, it means that a downlink LBT failure has occurred, and when the bit is 0, it means that a downlink LBT failure has not occurred.
Uplink LBT failure indication: used to indicate the occurrence of uplink LBT failure. It may be represented by a single bit. For example, when the bit is 1, it means that an uplink LBT failure has occurred, and when the bit is 0, it means that an uplink LBT failure has not occurred.
LBT failure indication: used to indicate the occurrence of LBT failure.

The above LBT failure may be continuous LBT failure. Herein the LBT failure detection information may refer to all fields and/or partial fields of the eleventh information, including, for example, user equipment identification, transmitting entity identification, receiving entity identification, serving cell identification, channel identification, LBT failure detection timer, maximum count of LBT failure instances, etc. Herein the LBT failure detection result may refer to all fields and/or partial fields of the eleventh information, including, for example, user equipment identification, transmitting entity identification, receiving entity identification, serving cell identification, channel identification, downlink LBT failure indication, uplink LBT failure indication, LBT failure indication, etc.

### Example 6

A sixth aspect of the present disclosure proposes a method for supporting self-optimization of a wireless communication network, which may include that: a second entity transmits twelfth information including LBT failure information available to a first entity, so as to inform the first entity that the second entity has LBT failure related information, so that the first entity may choose whether to acquire the information.

In some implementations, the twelfth information may be included in one or more of the following: UE-MeasurementsAvailable, RRCSetupComplete, RRCReestablishmentComplete, RRCReconfigurationComplete, and RRCResumeComplete of RRC; or an other and/or newly defined RRC and/or Xn and/or X2 and/or F1 and/or E1 and/or NG message.

In some implementations, the twelfth information may include one or more of the following fields or related information:
User equipment identification: used to indicate the identification of a UE corresponding to the available LBT failure information.
Transmitting entity identification: used to indicate the identification of an entity that transmits the twelfth information.
Receiving entity identification: used to indicate the identification of an entity that receives the twelfth information.
LBT failure information available: used to indicate that LBT failure information is available. This field may be represented by a single bit. For example, when the bit is 1, it means that LBT failure information is available, and when the bit is 0, it means that LBT failure information is not available.
LBT failure report available: used to indicate that LBT failure report is available. This field may be represented by a single bit. For example, when the bit is 1, it means that the LBT failure report is available, and when the bit is 0, it means that the LBT failure report is not available.
Continuous LBT failure information available: used to indicate that continuous LBT failure information is available. This field may be represented by a single bit. For example, when the bit is 1, it means that continuous LBT failure information is available, and when the bit is 0, it means that continuous LBT failure information is not available.
Continuous LBT failure report available: used to indicate that continuous LBT failure report is available. This field may be represented by a single bit. For example, when the bit is 1, it means that continuous LBT failure reports are available, and when the bit is 0, it means that continuous LBT failure reports are not available.

In some implementations, the first entity may transmit thirteenth information including LBT failure information request to the second entity according to its own situation (for example, autonomously) and/or according to the received information of LBT failure information available, so that the first entity may acquire LBT failure information and make self-optimization decisions.

In some implementations, the thirteenth information may be included in one or more of the following: UEInformationRequest of RRC; or an other and/or newly defined RRC and/or Xn and/or X2 and/or F1 and/or E1 and/or NG message.

In some implementations, the thirteenth information may include one or more of the following fields or related information:
User equipment identification: used to indicate the identification of a UE corresponding to the LBT failure information request.
Transmitting entity identification: used to indicate the identification of an entity that transmits the thirteenth information.
Receiving entity identification: used to indicate the identification of an entity that transmits the thirteenth information.
LBT failure information request: used to request LBT failure information. This field may be represented by a single bit. For example, when the bit is 1, it means that LBT failure information is requested, and when the bit is 0, it means that LBT failure information is not requested.
LBT failure report request: used to request LBT failure reports. This field may be represented by a single bit. For example, when the bit is 1, it means that LBT failure report is requested, and when the bit is 0, it means that LBT failure report is not requested.
Continuous LBT failure information request: used to request continuous LBT failure information. This field may be represented by a single bit. For example, when the bit is 1, it means that continuous LBT failure information is requested, and when the bit is 0, it means that continuous LBT failure information is not requested.
Continuous LBT failure report request: used to request continuous LBT failure report. This field may be represented by a single bit. For example, when the bit is 1, it means that continuous LBT failure report is requested, and when the bit is 0, it means that continuous LBT failure report is not requested.

In some implementations, the second entity may transmit fourteenth information including LBT failure information to the first entity according to its own situation (for example, autonomously) and/or according to the LBT failure information request, so as to provide reference information for the first entity to make self-optimization decisions.

In some implementations, the fourteenth information may be included in one or more of the following: UEInformationResponse, SCGFailureInformation, and MCGFailureInformation of RRC; FAILURE INDICATION message, HANDOVER REPORT message, ACCESS AND MOBILITY INDICATION message, S-NODE MODIFICATION REQUEST message, SgNB MODIFICATION REQUEST message, SCG FAILURE INFORMATION REPORT message, RRC TRANSFER message of Xn; ACCESS AND MOBILITY INDICATION message of F1; UPLINK RAN CONFIGURATION TRANSFER message and DOWNLINK RAN CONFIGURATION TRANSFER message of NG; or an other and/or newly defined RRC and/or Xn and/or X2 and/or F1 and/or E1 and/or NG message. Fourteenth information may also be included in a report, where the report may be a Connection Establishment Failure (CEF) report, a Random Access report, a Successful Handover report, a Radio Link Failure (RLF) report, a measurement report, or other reports related to wireless connection. The report may also be a new report, for example, it may be one or more of the following: LBT failure report, LBT report, continuous LBT failure report, unlicensed band access report, unlicensed band report, unlicensed band access failure report, unlicensed band failure report, shared spectrum access report, shared spectrum failure report, etc.

In some implementations, the fourteenth information may include one or more of the following fields or related information:
Received signal strength indicator (RSSI)
Channel occupancy (CO) time percentage
The number of LBT failure
Success rate or failure rate of LBT
Average transmission time duration after LBT success.
LBT failure detection timer: a timer used for continuous LBT failure detection. For example, during the running time of the timer, it is detected whether continuous LBT failure occurs. The timer may be for uplink, downlink, uplink and downlink, uplink or downlink, etc.
Maximum count of LBT failure instances: used to determine the number of LBT failures, which when reached, a subsequent process is activated, such as LBT failure recovery, LBT failure reporting, resource configuration updating, mobility optimization (e.g. handover), etc. The maximum count may be for uplink, downlink, uplink and downlink, uplink or downlink, etc.
Time length of LBT failure detection: the time length used for LBT failure detection, which may be from the beginning of LBT failure detection to the end of LBT failure detection and/or LBT failure confirmation. The time length may be for uplink, downlink, uplink and downlink, uplink or downlink, etc.
Count of LBT failure instances: a count used for LBT failure detection, which may be the number of LBT failures counted from the beginning of LBT failure detection to the end of LBT failure detection and/or LBT failure confirmation. The count may be for uplink, downlink, uplink and downlink, uplink or downlink, etc.
Downlink LBT failure indication: used to indicate the occurrence of a downlink LBT failure. It may be represented by a single bit. For example, when the bit is 1, it means that a downlink LBT failure has occurred, and when the bit is 0, it means that a downlink LBT failure has not occurred.
Uplink LBT failure indication: used to indicate the occurrence of an uplink LBT failure. It may be represented by a single bit. For example, when the bit is 1, it means that an uplink LBT failure has occurred, and when the bit is 0, it means that an uplink LBT failure has not occurred.
LBT failure indication: used to indicate the occurrence of a LBT failure.
Bandwidth part (BWP) where LBT failure occurs: including center frequency, bandwidth, channel indication, etc.
Resource configuration corresponding to LBT failure: including center frequency, bandwidth, channel indication, etc.
Resource activation configuration corresponding to LBT failure: including center frequency, bandwidth, channel indication, activation indication, etc.
RSSI corresponding to LBT failure: indicates the RSSI detected when LBT fails.
Detected energy corresponding to LBT failure: indicates the energy detected when LBT fails. The detected energy may be a corresponding detected energy when LBT fails, the maximum value of the detected energy, the minimum value of the detected energy, an average value of the detected energy, the latest detected energy, a difference between the detected energy and an applied ED threshold, or a difference between the detected energy and the maximum ED threshold, etc. The difference may be the maximum value, minimum value, latest value, or average value of a difference, etc. The detected energy may also be the average value, maximum value, minimum value, or latest value of a detected energy, etc. The applied ED threshold may be an applied ED threshold, the maximum value of an applied ED threshold, the minimum value of an applied ED threshold, etc. This information may be provided to corresponding nodes and/or entities, and the nodes and/or entities adjust LBT configuration based on this information, for example, configuration of the maximum ED threshold, etc., so as to improve the LBT success rate of the user. In an implementation, the maximum ED threshold should be set to be less than and/or equal to the minimum value of the detected energy corresponding to the LBT failure.
ED threshold corresponding to LBT failure: indicates the ED threshold applied when LBT fails. The corresponding ED threshold may be the applied ED threshold, the applied latest ED threshold, the applied maximum ED threshold, the applied minimum ED threshold, or the average value of the applied ED threshold when LBT fails, etc. This information may be provided to corresponding nodes and/or entities, and the nodes and/or entities adjust LBT configuration based on this information, for example, configuration of the maximum ED threshold, so as to improve the LBT success rate of the user.
Maximum ED threshold corresponding to LBT failure: indicates the maximum ED threshold applied when LBT fails.
Time information from LBT failure to reporting: indicates the time from LBT failure to reporting.
Time of LBT failure: indicates the time when LBT fails, which may be a relative time or an absolute time.
User equipment identification: used to indicate the identification of a UE corresponding to LBT failure.
Cell identification: used to indicate the identification of a cell corresponding to LBT failure.
Identification of a node where a cell is located: used to indicate the identification of a node where the cell corresponding to LBT failure is located.
Beam identification: used to indicate the identification of the beam corresponding to LBT failure.
Slice identification: used to indicate the identification of the slice corresponding to LBT failure.
PLMN identification: used to indicate the identification of the PLMN corresponding to LBT failure.
Band information indication: indicates the band information used for uplink and/or downlink. The band information may include one and/or more of the following:
Transmission direction indication: including uplink, downlink, uplink and downlink, uplink or downlink, etc.
Band type: including licensed band and unlicensed band.
Indication of using unlicensed band: represented by a single bit, for example, when the bit is 1, it indicates an unlicensed band, and when the bit is 0, it indicates a licensed band. Alternatively, when the bit is 0, it indicates an unlicensed band, and when the bit is 1, it indicates a licensed band.
Licensed band indication: represented by a single bit, for example, when the bit is 1, it indicates a licensed band, and when the bit is 0, it indicates an unlicensed band. Alternatively, when the bit is 0, it indicates a licensed band, and when the bit is 1, it indicates an unlicensed band.
Indication of using licensed band for uplink and using unlicensed band for downlink: represented by a single bit. For example, when the bit is 1, it means that a licensed band is used for uplink and an unlicensed band is used for downlink; when the bit is 0, it means that it is not the case that a licensed band is used for uplink and an unlicensed band is used for downlink. Alternatively, when the bit is 0, it means that a licensed band is used for uplink and an unlicensed band is used for downlink; when the bit is 1, it means that it is not the case that a licensed band is used for uplink and an unlicensed band is used for downlink.

The method performed by the first entity and/or the second entity in the wireless communication system according to embodiments of the present disclosure may be used for network self-optimization decision. The network self-optimization decision mentioned in the present disclosure may include network energy saving, load balancing, coverage optimization, mobility optimization and/or management, network configuration formulation and/or network configuration updating, etc.

Furthermore, in the present disclosure, results and reports may refer to each other. Results, reports and contents can refer to each other.

In addition, in the present disclosure, the data volume may be one or more of the following: Data Usage, Traffic, and Usage Count. The data volume may also include data characteristics, for example, may include one or more of the following: data arrival rate, data transmission rate, packet size, data service type, etc.

Furthermore, in the present disclosure, confidence and accuracy may refer to each other.

Furthermore, in the present disclosure, an Energy Detection (ED) threshold may be a configured maximum energy detection threshold or an applied energy detection threshold. The applied energy detection threshold may include one or more of the following: the applied ED threshold, the latest applied ED threshold, the maximum applied ED threshold, the minimum applied ED threshold, the average value of the applied ED threshold, situation of detected energy, etc.

Furthermore, in the present disclosure, the situation of detected energy may include one or more of the following: detected energy, maximum value of detected energy, minimum value of detected energy, average value of detected energy, latest detected energy, a difference between detected energy and an applied ED threshold, a difference between detected energy and the maximum ED threshold, etc. The difference may be the maximum value, minimum value, latest value, or average value of a difference, etc. The detected energy may also be the average value, maximum value, minimum value, or latest value of a detected energy, etc. The applied ED threshold may be an applied ED threshold, the maximum value of an applied ED threshold, the minimum value of an applied ED threshold, etc.

Furthermore, in the present disclosure, time may be represented by one or more of the following: timestamp, time point, time interval, timer, period of time, time length, time period/periodicity, time spacing, etc. Herein, the time length may be a length of time from a certain time point, which may be the current time. The time may be a relative time or an absolute time.

Furthermore, in the present disclosure, data volume may also refer to one or more of the following: amount of data, count of data, arrival rate of data, data volume and/or time of data burst, QoS requirement of data, arrival interval of data, arrival mode of data, etc. Herein, the arrival mode of data may include periodic arrival, indirect arrival and so on. The QoS requirement may include reliability, delay, throughput, packet loss rate and so on.

Furthermore, in the present disclosure, fields and/or information may be actual values, average values, latest values, maximum values, minimum values and the like of the information.

Furthermore, in the present disclosure, fields and/or information may be actual values, predicted values, estimated values, and the like.

Exemplary embodiments of the present disclosure are further described below with reference to the accompanying drawings.

The text and drawings are provided as examples only to help understand the present disclosure. They should not be construed as limiting the scope of the present disclosure in any way. Although certain embodiments and examples have been provided, based on the disclosure herein, it is apparent to those skilled in the art that changes can be made to the illustrated embodiments and examples without departing from the scope of the present disclosure.

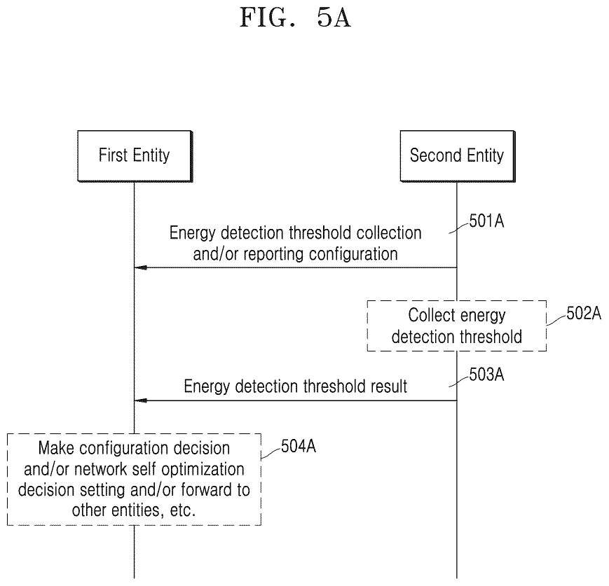

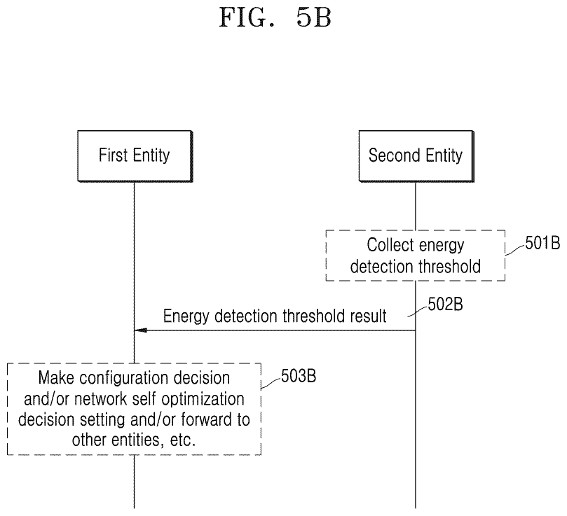

FIG. 5a illustrates a schematic diagram of an aspect of a method for supporting self-optimization of a wireless communication network according to embodiments of the present disclosure. Specifically, FIG. 5a illustrates a process of exchanging LBT energy detection threshold between two entities, so that the first entity may acquire the energy detection threshold information of the second entity in the LBT process, and provide reference information for subsequent load information exchange, maximum energy detection threshold updating, etc., so as to provide reference information for load balancing decision and improve the robustness of the LBT transmission mechanism.

In some implementations, for example, the first entity may be a gNB or gNB-CU or gNB-DU or gNB CU-CP or gNB CU-UP or en-gNB or eNB or ng-eNB, and the second entity may be a UE. In other implementations, for example, the first entity may be a gNB or gNB-CU or gNB CU-CP or en-gNB or eNB or ng-eNB, and the second entity may be a gNB or gNB-CU or gNB-DU or gNB CU-CP or gNB CU-UP or en-gNB or eNB or ng-eNB. In still other implementations, for example, the first entity may be an AMF or SMF or MME, and the second entity may be a gNB or gNB-CU or gNB CU-CP or en-gNB or eNB or ng-eNB. In yet other implementations, for example, the first entity may be a gNB or gNB-CU or gNB CU-CP or en-gNB or eNB or ng-eNB, and the second entity may be an AMF or SMF or MME.

Step 501A: the first entity transmits an energy detection threshold collection and/or reporting configuration to the second entity. The energy detection threshold collection and/or reporting configuration may be the aforementioned first information.

Step 502A: the second entity collects the energy detection threshold.

Step 503A: the second entity reports the energy detection threshold to the first entity. The energy detection threshold may be the aforementioned second information. If the second entity is unable to report the energy detection threshold according to the configuration in step 501A, the second entity may transmit to the first entity information including the energy detection threshold result that cannot be reported, which may be the aforementioned third information.

Step 504A: the first entity makes configuration decision and/or network self-optimization decision setting based on the collected energy detection threshold results and/or forwards it to other entities.

If the configuration information in step 501A requires the second entity to report periodically, step 502A and/or step 503A are performed periodically.

FIG. 5b illustrates a schematic diagram of an aspect of a method for supporting self-optimization of a wireless communication network according to embodiments of the present disclosure. Specifically, FIG. 5b illustrates a process of exchanging LBT energy detection threshold between two entities, so that the first entity may acquire the energy detection threshold information of the second entity in the LBT process, and provide reference information for subsequent load information exchange, maximum energy detection threshold updating, etc., so as to provide reference information for load balancing decision and improve the robustness of the LBT transmission mechanism.

In some implementations, for example, the first entity may be a gNB or gNB-CU or gNB-DU or gNB CU-CP or gNB CU-UP or en-gNB or eNB or ng-eNB, and the second entity may be a UE. In other implementations, for example, the first entity may be a gNB or gNB-CU or gNB CU-CP or en-gNB or eNB or ng-eNB, and the second entity may be a gNB or gNB-CU or gNB-DU or gNB CU-CP or gNB CU-UP or en-gNB or eNB or ng-eNB. In still other implementations, for example, the first entity may be an AMF or SMF or MME, and the second entity may be a gNB or gNB-CU or gNB CU-CP or en-gNB or eNB or ng-eNB. In yet other implementations, for example, the first entity may be a gNB or gNB-CU or gNB CU-CP or en-gNB or eNB or ng-eNB, and the second entity may be an AMF or SMF or MME.

Step 501B: the second entity collects the energy detection threshold.

Step 502B: the second entity reports the energy detection threshold to the first entity. The energy detection threshold may be the aforementioned second information.

Step 503B: the first entity makes configuration decision and/or network self-optimization decision setting based on the collected energy detection threshold results and/or forwards it to other entities.

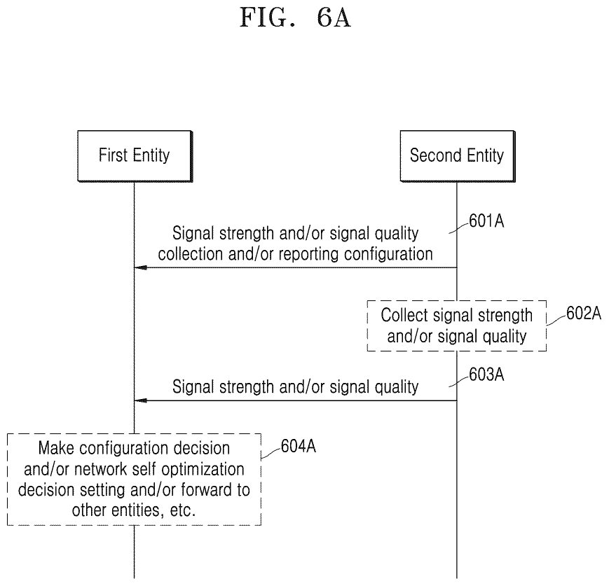

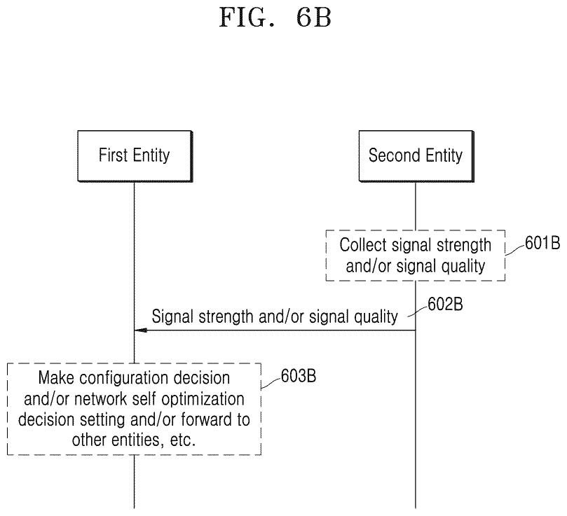

FIG. 6a illustrates a schematic diagram of an aspect of a method for supporting self-optimization of a wireless communication network according to embodiments of the present disclosure. Specifically, FIG. 6a illustrates a process of exchanging signal strength and/or signal quality between two entities, so that the first entity may acquire the related information of signal strength and/or signal quality collected by the second entity, and provide reference information for the first entity to perform resource configuration.

In some implementations, for example, the first entity may be a gNB or gNB-CU or gNB-DU or gNB CU-CP or gNB CU-UP or en-gNB or eNB or ng-eNB, and the second entity may be a UE. In other implementations, for example, the first entity may be a gNB or gNB-CU or gNB CU-CP or en-gNB or eNB or ng-eNB, and the second entity may be a gNB or gNB-CU or gNB-DU or gNB CU-CP or gNB CU-UP or en-gNB or eNB or ng-eNB. In still other implementations, for example, the first entity may be an AMF or SMF or MME, and the second entity may be a gNB or gNB-CU or gNB CU-CP or en-gNB or eNB or ng-eNB. In yet other implementations, for example, the first entity may be a gNB or gNB-CU or gNB CU-CP or en-gNB or eNB or ng-eNB, and the second entity may be an AMF or SMF or MME.

Step 601A: the first entity transmits a signal strength and/or signal quality collection and/or reporting configuration to the second entity. The signal strength and/or signal quality collection and/or reporting configuration may be the aforementioned fourth information.

Step 602A: the second entity collects signal strength and/or signal quality.

Step 603A: the second entity reports the signal strength and/or signal quality to the first entity. The signal strength and/or signal quality may be the aforementioned fifth information.

Step 604A: the first entity makes configuration decision and/or network self-optimization decision setting based on the collected signal strength and/or signal quality and/or forwards it to other entities.

If the configuration information in step 601A requires the second entity to report periodically, step 602A and/or step 603A are performed periodically.

FIG. 6b illustrates a schematic diagram of an aspect of a method for supporting self-optimization of a wireless communication network according to embodiments of the present disclosure. Specifically, FIG. 6b illustrates a process of exchanging signal strength and/or signal quality between two entities, so that the first entity may acquire the related information of signal strength and/or signal quality collected by the second entity, and provide reference information for the first entity to perform resource configuration.

In some implementations, for example, the first entity may be a gNB or gNB-CU or gNB-DU or gNB CU-CP or gNB CU-UP or en-gNB or eNB or ng-eNB, and the second entity may be a UE. In other implementations, for example, the first entity may be a gNB or gNB-CU or gNB CU-CP or en-gNB or eNB or ng-eNB, and the second entity may be a gNB or gNB-CU or gNB-DU or gNB CU-CP or gNB CU-UP or en-gNB or eNB or ng-eNB. In still other implementations, for example, the first entity may be an AMF or SMF or MME, and the second entity may be a gNB or gNB-CU or gNB CU-CP or en-gNB or eNB or ng-eNB. In yet other implementations, for example, the first entity may be a gNB or gNB-CU or gNB CU-CP or en-gNB or eNB or ng-eNB, and the second entity may be an AMF or SMF or MME.

Step 601B: the second entity collects signal strength and/or signal quality.

Step 602B: the second entity reports the signal strength and/or signal quality to the first entity. The signal strength and/or signal quality may be the aforementioned fifth information.

Step 603B: the first entity makes configuration decision and/or network self-optimization decision setting based on the collected signal strength and/or signal quality and/or forwards it to other entities.

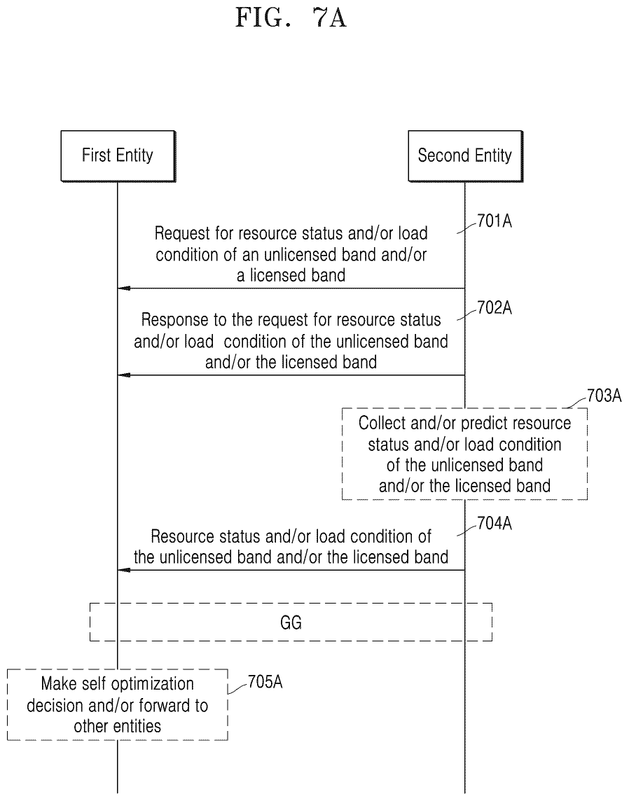

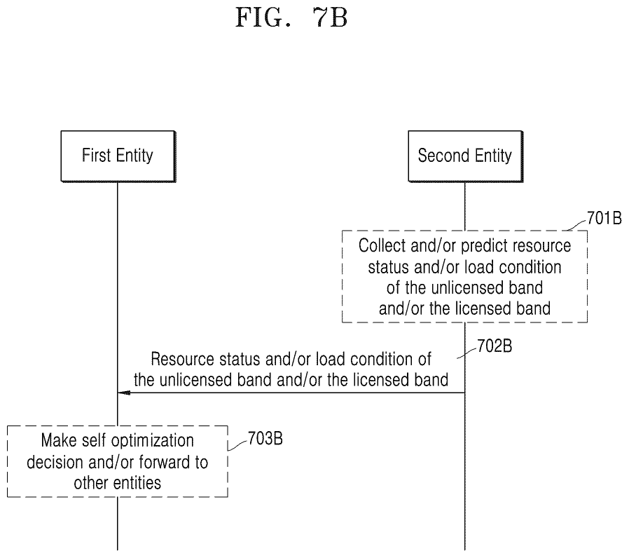

FIG. 7a illustrates a schematic diagram of an aspect of a method for supporting self-optimization of a wireless communication network according to embodiments of the present disclosure. Specifically, FIG. 7a illustrates a process of exchanging resource status and/or load situation of an unlicensed band and/or a licensed band between two entities, so that the first entity may acquire the resource status and/or load situation of the unlicensed band and/or the licensed band of the second entity and/or other entities, so as to provide reference information for the first entity to make self-optimization decision.

In some implementations, for example, the first entity may be a gNB or gNB-CU or gNB-DU or gNB CU-CP or gNB CU-UP or en-gNB or eNB or ng-eNB, and the second entity may be a UE. In other implementations, for example, the first entity may be a gNB or gNB-CU or gNB CU-CP or en-gNB or eNB or ng-NB, and the second entity may be a gNB or gNB-CU or gNB-DU or gNB CU-CP or gNB CU-UP or en-gNB or eNB or ng-eNB. In still other implementations, for example, the first entity may be an AMF or SMF or MME, and the second entity may be a gNB or gNB-CU or gNB CU-CP or en-gNB or eNB or ng-eNB. In yet other implementations, for example, the first entity may be a gNB or gNB-CU or gNB CU-CP or en-gNB or eNB or ng-eNB, and the second entity may be an AMF or SMF or MME.

Step 701A: the first entity transmits a request for resource status and/or load situation of an unlicensed band and/or a licensed band to the second entity. The request for resource status and/or load situation of the unlicensed band and/or the licensed band may be the aforementioned sixth information.

Step 702A: the second entity transmits a response to the request for resource status and/or load situation of the unlicensed band and/or the licensed band to the first entity. The response to the request for resource status and/or load situation of the unlicensed band and/or the licensed band may be the aforementioned seventh information.

Step 703A: the second entity collects the resource status and/or load situation of the unlicensed band and/or the licensed band and/or predicts the resource status and/or load situation of the unlicensed band and/or the licensed band.

Step 704A: the second entity transmits the resource status and/or load situation of the unlicensed band and/or the licensed band to the first entity. The resource status and/or load situation of the unlicensed band and/or the licensed band may be the aforementioned eighth information.

Step 704A: the first entity makes network self-optimization decision setting based on the collected resource status and/or load situation of the unlicensed band and/or the licensed band and/or forwards it to other entities.

If the request information in step 701A requires the second entity to report periodically, step 703A and/or step 704A arc performed periodically.

FIG. 7b illustrates a schematic diagram of an aspect of a method for supporting self-optimization of a wireless communication network according to embodiments of the present disclosure. Specifically, FIG. 7b illustrates a process of exchanging resource status and/or load situation of an unlicensed band and/or a licensed band between two entities, so that the first entity may acquire the resource status and/or load situation of the unlicensed band and/or the licensed band of the second entity and/or other entities, so as to provide reference information for the first entity to make self-optimization decision.

In some implementations, for example, the first entity may be a gNB or gNB-CU or gNB-DU or gNB CU-CP or gNB CU-UP or en-gNB or eNB or ng-eNB, and the second entity may be a UE. In other implementations, for example, the first entity may be a gNB or gNB-CU or gNB CU-CP or en-gNB or eNB or ng-eNB, and the second entity may be a gNB or gNB-CU or gNB-DU or gNB CU-CP or gNB CU-UP or en-gNB or eNB or ng-eNB. In still other implementations, for example, the first entity may be an AMF or SMF or MME, and the second entity may be a gNB or gNB-CU or gNB CU-CP or en-gNB or eNB or ng-eNB. In yet other implementations, for example, the first entity may be a gNB or gNB-CU or gNB CU-CP or en-gNB or eNB or ng-eNB, and the second entity may be an AMF or SMF or MME.

Step 701B: the second entity collects the resource status and/or load situation of the unlicensed band and/or the licensed band and/or predicts the resource status and/or load situation of the unlicensed band and/or the licensed band.

Step 702B: the second entity transmits the resource status and/or load situation of the unlicensed band and/or the licensed band to the first entity. The resource status and/or load situation of the unlicensed band and/or the licensed band may be the aforementioned eighth information.

Step 703B: the first entity makes network self-optimization decision setting based on the collected resource status and/or load situation of the unlicensed band and/or the licensed band and/or forwards it to other entities.

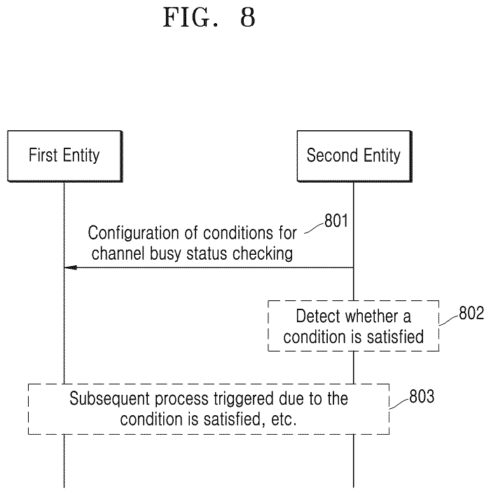

FIG. 8 illustrates a schematic diagram of an aspect of a method for supporting self-optimization of a wireless communication network according to embodiments of the present disclosure. Specifically, FIG. 8 illustrates that a first entity configures a configuration of conditions for channel busy status checking to a second entity, and the second entity checks whether the conditions are satisfied according to the configuration to determine whether to trigger a subsequent process, so as to prevent the second entity to be handed over to a cell in a channel busy status, affecting performance, and to enable the second entity to successfully perform conditional handover, etc.

In some implementations, for example, the first entity may be a gNB or gNB-CU or gNB-DU or gNB CU-CP or gNB CU-UP or en-gNB or eNB or ng-eNB, and the second entity may be a UE. In other implementations, for example, the first entity may be a gNB or gNB-CU or gNB CU-CP or en-gNB or eNB or ng-eNB, and the second entity may be a gNB or gNB-CU or gNB-DU or gNB CU-CP or gNB CU-UP or en-gNB or eNB or ng-eNB. In still other implementations, for example, the first entity may be an AMF or SMF or MME, and the second entity may be a gNB or gNB-CU or gNB CU-CP or en-gNB or eNB or ng-eNB. In yet other implementations, for example, the first entity may be a gNB or gNB-CU or gNB CU-CP or en-gNB or eNB or ng-eNB, and the second entity may be an AMF or SMF or MME.

Step 801: the first entity transmits a configuration of conditions for channel busy status checking to the second entity. The configuration of conditions for channel busy status checking may be the aforementioned ninth information.

Step 802: the second entity detects whether a condition is satisfied.

Step 803: if the condition is satisfied, a subsequent process, such as conditional handover, is triggered.

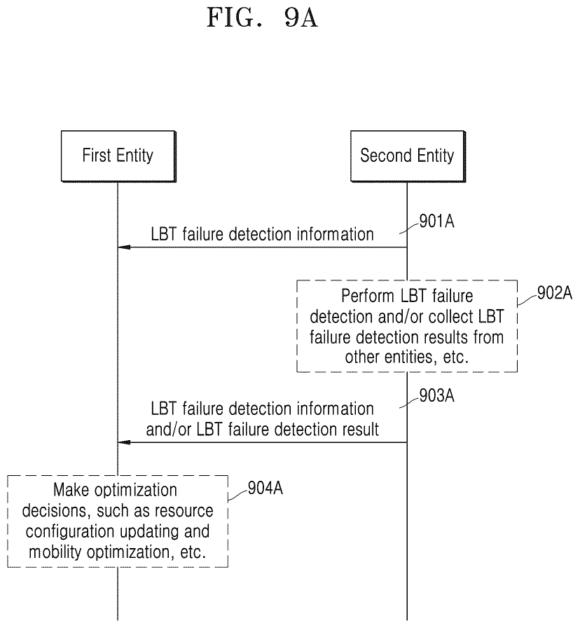

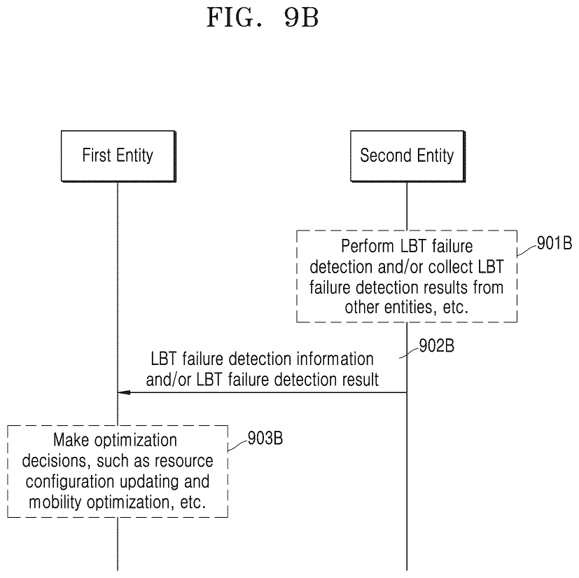

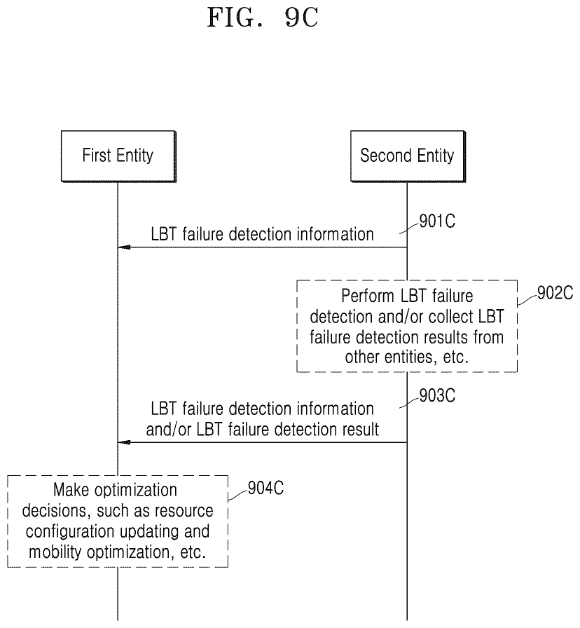

FIG. 9a illustrates a schematic diagram of an aspect of a method for supporting self-optimization of a wireless communication network according to embodiments of the present disclosure. Specifically, FIG. 9a illustrates a process of exchanging LBT failure detection information and/or LBT failure detection results between two entities, so that the first entity may acquire LBT failure detection information and/or results, and the first entity can make optimization decisions, such as resource configuration updating, mobility optimization (e.g., handover), etc.

In some implementations, for example, the first entity may be a gNB or gNB-CU or gNB-DU or gNB CU-CP or gNB CU-UP or en-gNB or eNB or ng-eNB, and the second entity may be a UE. In other implementations, for example, the first entity may be a gNB or gNB-CU or gNB CU-CP or en-gNB or eNB or ng-eNB, and the second entity may be a gNB or gNB-CU or gNB-DU or gNB CU-CP or gNB CU-UP or en-gNB or eNB or ng-eNB. In still other implementations, for example, the first entity may be an AMF or SMF or MME, and the second entity may be a gNB or gNB-CU or gNB CU-CP or en-gNB or eNB or ng-eNB. In yet other implementations, for example, the first entity may be a gNB or gNB-CU or gNB CU-CP or en-gNB or eNB or ng-eNB, and the second entity may be an AMF or SMF or MME.

Step 901A: the first entity transmits an LBT failure detection configuration to the second entity. The LBT failure detection configuration may be the aforementioned tenth information.

Step 902A: the second entity performs LBT failure detection and/or collects LBT failure detection results from other entities.

Step 903A: the second entity reports the LBT failure detection information and/or LBT failure detection result to the first entity. The LBT failure detection information and/or the LBT failure detection result may be the aforementioned eleventh information.

Step 904A: the first entity may make optimization decisions, such as resource configuration updating and mobility optimization (e.g., handover), based on the collected LBT failure detection information and/or result.

FIG. 9b illustrates a schematic diagram of an aspect of a method for supporting self-optimization of a wireless communication network according to embodiments of the present disclosure. Specifically, FIG. 9b illustrates a process of exchanging LBT failure detection information and/or LBT failure detection results between two entities, so that the first entity may acquire LBT failure detection information and/or results, and the first entity can make optimization decisions, such as resource configuration updating, mobility optimization (e.g., handover), etc.

In some implementations, for example, the first entity may be a gNB or gNB-CU or gNB-DU or gNB CU-CP or gNB CU-UP or en-gNB or eNB or ng-eNB, and the second entity may be a UE. In other implementations, for example, the first entity may be a gNB or gNB-CU or gNB CU-CP or en-gNB or eNB or ng-eNB, and the second entity may be a gNB or gNB-CU or gNB-DU or gNB CU-CP or gNB CU-UP or en-gNB or eNB or ng-eNB. In still other implementations, for example, the first entity may be an AMF or SMF or MME, and the second entity may be a gNB or gNB-CU or gNB CU-CP or en-gNB or eNB or ng-eNB. In yet other implementations, for example, the first entity may be a gNB or gNB-CU or gNB CU-CP or en-gNB or eNB or ng-eNB, and the second entity may be an AMF or SMF or MME.

Step 901B: the second entity performs LBT failure detection and/or collects LBT failure detection results from other entities.

Step 902B: the second entity reports the LBT failure detection information and/or LBT failure detection result to the first entity. The LBT failure detection information and/or the LBT failure detection result may be the aforementioned eleventh information.

Step 903B: the first entity may make optimization decisions, such as resource configuration updating and mobility optimization (e.g., handover), based on the collected LBT failure detection information and/or result.

FIG. 9c illustrates a schematic diagram of an aspect of a method for supporting self-optimization of a wireless communication network according to embodiments of the present disclosure. Specifically, FIG. 9c illustrates a process of exchanging LBT failure detection information and/or LBT failure detection results between two entities, so that the first entity may acquire LBT failure detection information and/or results, and the first entity can make optimization decisions, such as resource configuration updating, mobility optimization (e.g., handover), etc.

In some implementations, for example, the first entity may be a gNB or gNB-CU or gNB-DU or gNB CU-CP or gNB CU-UP or en-gNB or eNB or ng-eNB, and the second entity may be a UE. In other implementations, for example, the first entity may be a gNB or gNB-CU or gNB CU-CP or en-gNB or eNB or ng-eNB, and the second entity may be a gNB or gNB-CU or gNB-DU or gNB CU-CP or gNB CU-UP or en-gNB or eNB or ng-eNB. In still other implementations, for example, the first entity may be an AMF or SMF or MME, and the second entity may be a gNB or gNB-CU or gNB CU-CP or en-gNB or eNB or ng-eNB. In yet other implementations, for example, the first entity may be a gNB or gNB-CU or gNB CU-CP or en-gNB or eNB or ng-eNB, and the second entity may be an AMF or SMF or MME.

Step 901C: the second entity reports the LBT failure detection information to the first entity. The LBT failure detection information may be the aforementioned eleventh information. Here, the LBT failure detection information may be the LBT failure detection information that the second entity itself has acquired and/or is currently using.

Step 902C: the second entity performs LBT failure detection and/or collects LBT failure detection results from other entities.

Step 903C: the second entity reports the LBT failure detection result and/or LBT failure detection information to the first entity. The LBT failure detection result may be the aforementioned eleventh information.

Step 904C: the first entity may make optimization decisions, such as resource configuration updating and mobility optimization (e.g., handover), based on the collected LBT failure detection information and/or result.

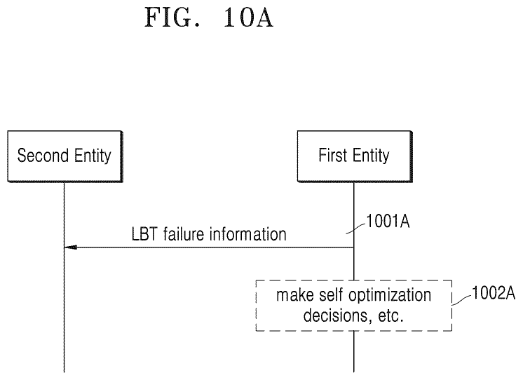

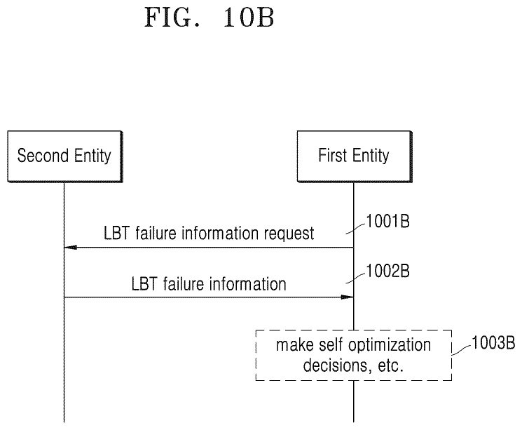

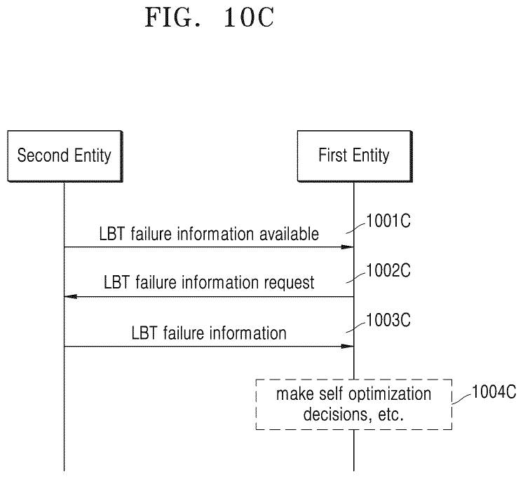

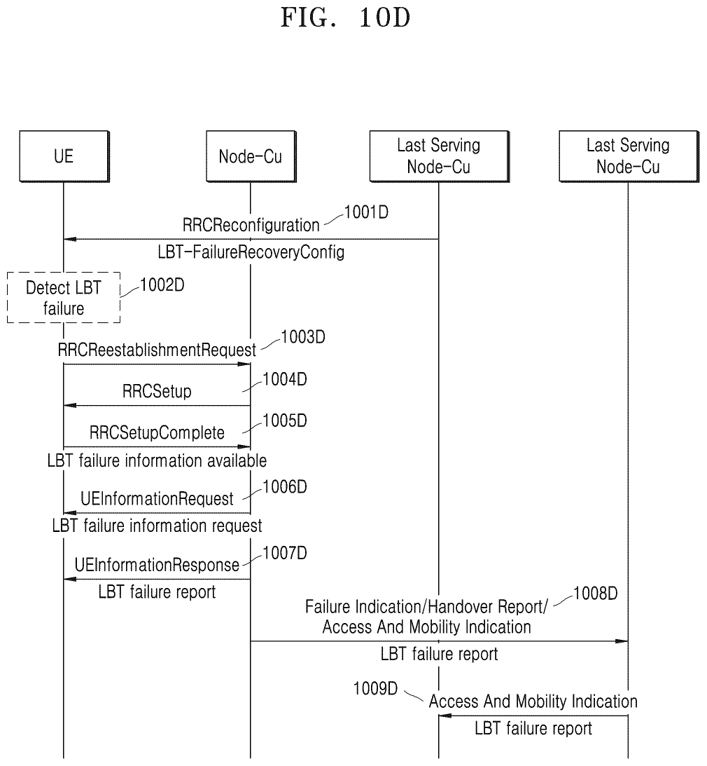

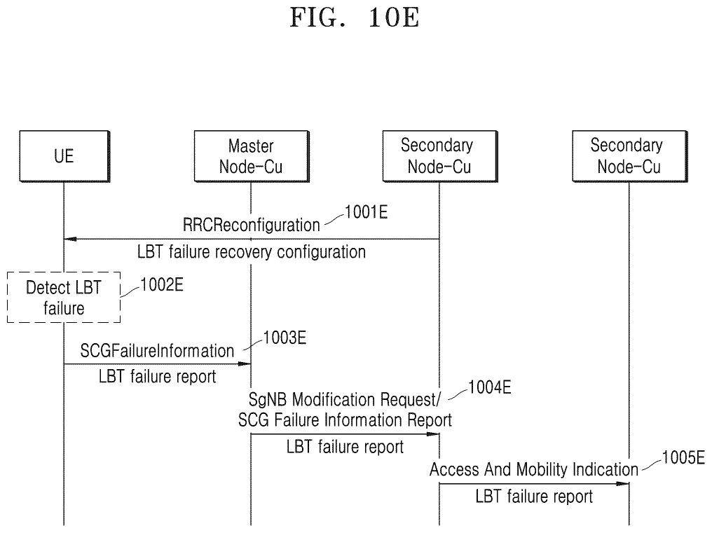

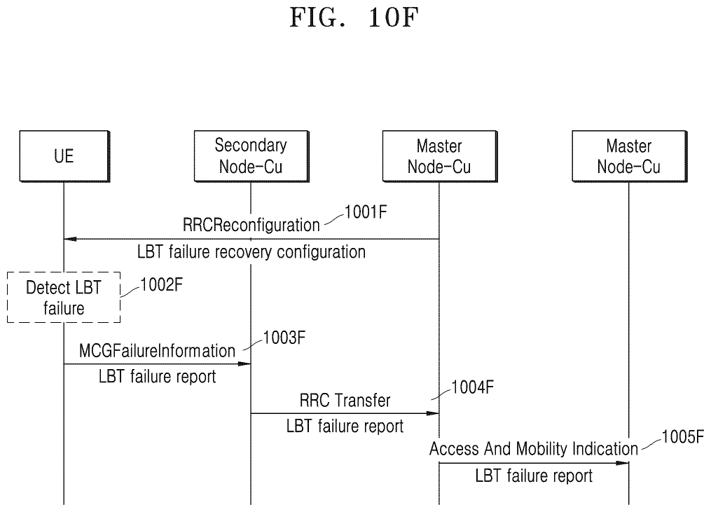

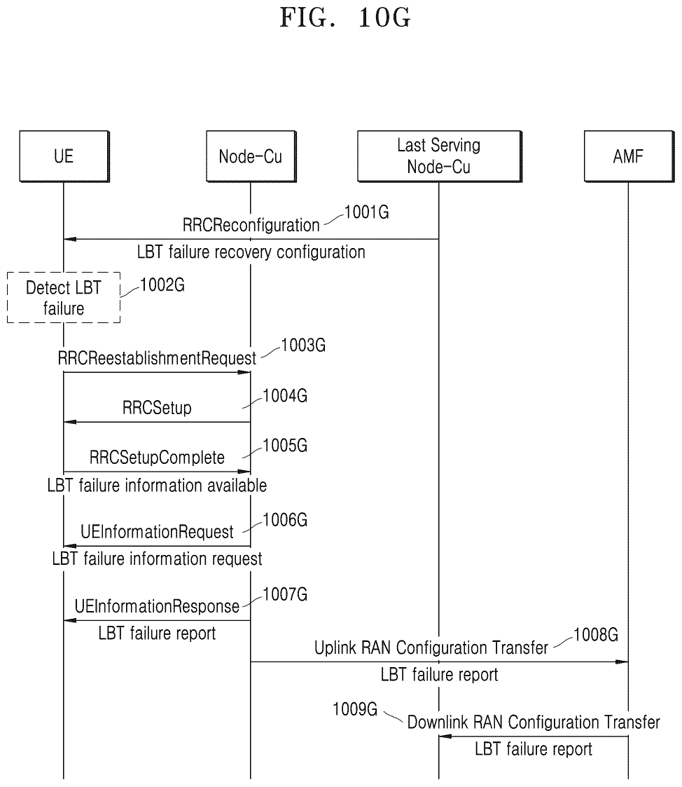

FIG. 10a illustrates a schematic diagram of an aspect of a method for supporting self-optimization of a wireless communication network according to embodiments of the present disclosure. Specifically, FIG. 10A illustrates a process of exchanging LBT failure information between two entities, so that the first entity may acquire LBT failure information and make self-optimization decisions.

In some implementations, for example, the second entity may be a UE, and the first entity may be a gNB or gNB-CU or gNB-DU or gNB CU-CP or gNB CU-UP or en-gNB or eNB or ng-eNB. In other implementations, for example, the second entity may be a gNB or gNB-CU or gNB-DU or gNB CU-CP or gNB CU-UP or en-gNB or eNB or ng-eNB, and the first entity may be a gNB or gNB-CU or gNB-DU or gNB CU-CP or gNB CU-UP or en-gNB or eNB or ng-eNB. In still other implementations, for example, the second entity may be an AMF or SMF or MME, and the first entity may be a gNB or gNB-CU or gNB CU-CP or en-gNB or eNB or ng-eNB. In yet other implementations, for example, the second entity may be a gNB or gNB-CU or gNB CU-CP or en-gNB or eNB or ng-eNB, and the first entity may be an AMF or SMF or MME.

Step 1001A: the second entity reports the LBT failure information to the first entity. The LBT failure information may be the aforementioned fourteenth information.

Step 1002A: the first entity makes self-optimization decisions and so on based on the collected LBT failure information.

FIG. 10b illustrates a schematic diagram of an aspect of a method for supporting self-optimization of a wireless communication network according to embodiments of the present disclosure. Specifically, FIG. 10b illustrates a process of exchanging LBT failure information between two entities, so that the first entity may acquire LBT failure information and make self-optimization decisions.

In some implementations, for example, the second entity may be a UE, and the first entity may be a gNB or gNB-CU or gNB-DU or gNB CU-CP or gNB CU-UP or en-gNB or eNB or ng-eNB. In other implementations, for example, the second entity may be a gNB or gNB-CU or gNB-DU or gNB CU-CP or gNB CU-UP or en-gNB or eNB or ng-eNB, and the first entity may be a gNB or gNB-CU or gNB-DU or gNB CU-CP or gNB CU-UP or en-gNB or eNB or ng-eNB. In still other implementations, for example, the second entity may be an AMF or SMF or MME, and the first entity may be a gNB or gNB-CU or gNB CU-CP or en-gNB or eNB or ng-eNB. In yet other implementations, for example, the second entity may be a gNB or gNB-CU or gNB CU-CP or en-gNB or eNB or ng-eNB, and the first entity may be an AMF or SMF or MME.

Step 1001B: the first entity transmits an LBT failure information request to the second entity to request the second entity to report the LBT failure information. The LBT failure information request may be the aforementioned thirteenth information.

Step 1002B: the second entity reports the LBT failure information to the first entity. The LBT failure information may be the aforementioned fourteenth information.

Step 1003B: the first entity makes self-optimization decisions and so on based on the collected LBT failure information.

FIG. 10c illustrates a schematic diagram of an aspect of a method for supporting self-optimization of a wireless communication network according to embodiments of the present disclosure. Specifically, FIG. 10c illustrates a process of exchanging LBT failure information between two entities, so that the first entity may acquire LBT failure information and make self-optimization decisions.

In some implementations, for example, the second entity may be a UE, and the first entity may be a gNB or gNB-CU or gNB-DU or gNB CU-CP or gNB CU-UP or en-gNB or eNB or ng-eNB. In other implementations, for example, the second entity may be a gNB or gNB-CU or gNB-DU or gNB CU-CP or gNB CU-UP or en-gNB or eNB or ng-eNB, and the first entity may be a gNB or gNB-CU or gNB-DU or gNB CU-CP or gNB CU-UP or en-gNB or eNB or ng-NB. In still other implementations, for example, the second entity may be an AMF or SMF or MME, and the first entity may be a gNB or gNB-CU or gNB CU-CP or en-gNB or eNB or ng-eNB. In yet other implementations, for example, the second entity may be a gNB or gNB-CU or gNB CU-CP or en-gNB or eNB or ng-eNB, and the first entity may be an AMF or SMF or MME.

Step 1001C: the second entity transmits information including or indicating that LBT failure information is available to the first entity, so as to inform the first entity that the second entity has LBT failure information. The information including or indicating that LBT failure information is available may be the aforementioned twelfth information.

Step 1002C: the first entity transmits an LBT failure information request to the second entity to request the second entity to report LBT failure information. The LBT failure information request may be the aforementioned thirteenth information.

Step 1003C: the second entity reports LBT failure information to the first entity. The LBT failure information may be the aforementioned fourteenth information.

Step 1004C: the first entity makes self-optimization decisions and so on based on the collected LBT failure information.

FIG. 10d illustrates a schematic diagram of an aspect of a method for supporting self-optimization of a wireless communication network according to embodiments of the present disclosure. Specifically, FIG. 10d illustrates a process of exchanging LBT failure information among a UE, a node and a last serving node, so that the last serving node can acquire LBT failure information, so that the last serving node can make configuration adjustment and make self-optimization decisions. As described above, a node may be a base station, which may include a central unit (CU) and a distributed unit (DU), and the CU may further include a user plane (UP) and a control plane (CP).

Step 1001D: the last serving node (or CU of the last serving node) transmits an LBTFailureRecoveryConfig to the UE, which may be an RRCReconfiguration message.

Step 1002D: the UE detects LBT failure.

Step 1003D: the UE transmits an RRCReestablishmentRequest to the node (or CU of the node).

Step 1004D: the node (or CU of the node) transmits an RRCSetup message to the UE.

Step 1005D: the UE transmits information including LBT failure information to the node (or CU of the node) to inform the node (or CU of the node) that the UE has the LBT failure information. The information including that the LBT failure information is available may be the aforementioned twelfth information. The information including that the LBT failure information is available may be transmitted by an RRCSetupComplete message.

Step 1006D: the node (or CU of the node) transmits an LBT failure information request to the UE to request the UE to report LBT failure information. The LBT failure information request may be the aforementioned thirteenth information. The LBT failure information request may be transmitted by a UEInformationRequest message.

Step 1007D: the UE transmits an LBT failure report to the node (or CU of the node). The LBT failure report may be the aforementioned fourteenth information. The LBT failure report may be transmitted through a UEInformationResponse message.

Step 1008D: the node (or CU of the node) transmits an LBT failure report to the last serving node (or CU of the last serving node). The LBT failure report may be the aforementioned fourteenth information. The LBT failure report may include all information and/or part of information in step 1007D. The LBT failure report may be transmitted by a Failure Indication/Handover Report and/or an Access And Mobility Indication message.

Step 1009D: the CU of the last serving node transmits an LBT failure report to the DU of the last serving node. The LBT failure report may be the aforementioned fourteenth information. The LBT failure report may include all information and/or part of information in step 1008D. The LBT failure report may be transmitted through an Access And Mobility Indication message.

The last serving node (or the CU of the last serving node or the DU of the last serving node) can make self-optimization decisions and/or update configuration based on the received LBT failure report.

FIG. 10e illustrates a schematic diagram of an aspect of a method for supporting self-optimization of a wireless communication network according to embodiments of the present disclosure. Specifically, FIG. 10e illustrates a process of exchanging LBT failure information among a UE, a master node and a secondary node when LBT failure occurs in resources configured by the secondary node in the case of dual-connectivity, so that the secondary node can acquire LBT failure information, so that the secondary node can make configuration adjustment and make self-optimization decisions.

Step 1001E: the secondary node (which may also be the CU of the secondary node transmits a LBT failure recovery configuration to the UE, which may be an RRCReconfiguration message.

Step 1002E: the UE detects LBT failure.

Step 1003E: the UE transmits an LBT failure report to the master node (or CU of the master node). The LBT failure report may be the aforementioned fourteenth information. The LBT failure report may be transmitted by SCGFailureInformation message.

Step 1004E: the master node (which may also be the CU of the master node) transmits an LBT failure report to the secondary node (which may also be the CU of the secondary node). The LBT failure report may be the aforementioned fourteenth information. The LBT failure report may include all information and/or part of information in step 1003E. The LBT failure report may be transmitted through a SgNB Modification Request and/or an SCG Failure Information Report message.

Step 1005E: the CU of the secondary node transmits an LBT failure report to the DU of the secondary node. The LBT failure report may be the aforementioned fourteenth information. The LBT failure report may include all information and/or part of information in step 1004E. The LBT failure report may be transmitted through an Access And Mobility Indication message.

The master node (which may also be the CU of the master node) and the secondary node (which may also be the CU of the secondary node or the DU of the secondary node) can make self-optimization decisions and/or update configurations based on the received LBT failure report.

FIG. 10f illustrates a schematic diagram of an aspect of a method for supporting self-optimization of a wireless communication network according to embodiments of the present disclosure. Specifically, FIG. 10f illustrates a process of exchanging LBT failure information among a UE, a master node and a secondary node when LBT failure occurs in resources configured by the master node in the case of dual-connectivity, so that the master node can acquire LBT failure information, so that the master node can make configuration adjustment and make self-optimization decisions.

Step 1001F: the master node (or CU of the master node) transmits a LBT failure recovery configuration to the UE, which may be an RRCReconfiguration message.

Step 1002F: the UE detects LBT failure.

Step 1003F: the UE transmits an LBT failure report to the secondary node (which may also be the CU of the secondary node). The LBT failure report may be the aforementioned fourteenth information. The LBT failure report may be transmitted through a Master Cell Group failure information (MCGGailureInformation) message.

Step 1004F: the secondary node (which may also be the CU of the secondary node) transmits an LBT failure report to the master node (which may also be the CU of the master node). The LBT failure report may be the aforementioned fourteenth information. The LBT failure report may include all information and/or part of information in step 1003F. The LBT failure report may be transmitted by an RRC Transfer message.

Step 1005F: the CU of the master node transmits an LBT failure report to the DU of the master node. The LBT failure report may be the aforementioned fourteenth information. The LBT failure report may include all the information and/or part of the information in step 1004F. The LBT failure report may be transmitted through an Access And Mobility Indication message.

The master node (or the CU of the master node or the DU of the master node) can make self-optimization decisions and/or update configuration based on the received LBT failure report.

FIG. 10g illustrates a schematic diagram of an aspect of a method for supporting self-optimization of a wireless communication network according to embodiments of the present disclosure. Specifically, FIG. 10g illustrates a process of exchanging LBT failure information among a UE, a node, a last serving node and an AMF, so that the last serving node can acquire LBT failure information, so that the last serving node can make configuration adjustment and make self-optimization decisions.

Step 1001G: the last serving node (or CU of the last serving node) transmits an LBT failure recovery configuration to the UE, which may be an RRCReconfiguration message.

Step 1002G: the UE detects LBT failure.

Step 1003G: the UE transmits an RRCReestablishmentRequest to the node (or CU of the node).

Step 1004G: the node (or CU of the node) transmits an RRCSetup message to the UE.

Step 1005G: the UE transmits information including LBT failure information available to the node (or CU of the node) to inform the node (or CU of the node) that the UE has LBT failure information. The information including LBT failure information available may be the aforementioned twelfth information. The information including LBT failure information available may be transmitted by an RRCSetupComplete message.

Step 1006G: the node (or CU of the node) transmits an LBT failure information request to the UE to request the UE to report LBT failure information. The LBT failure information request may be the aforementioned thirteenth information. The LBT failure information request may be transmitted by a UEInformationRequest message.

Step 1007G: the UE transmits an LBT failure report to the node (or CU of the node). The LBT failure report may be the aforementioned fourteenth information. The LBT failure report may be transmitted through a UEInformationResponse message.

Step 1008G: the node (or CU of the node) transmits an LBT failure report to the AMF. The LBT failure report may be the aforementioned fourteenth information. The LBT failure report may include all information and/or part of information in step 1007G. The LBT failure report may be transmitted through an Uplink RAN Configuration Transfer message.

Step 1009G: the AMF transmits an LBT failure report to the last serving node (or CU of the last serving node). The LBT failure report may be the aforementioned fourteenth information. The LBT failure report may include all information and/or part of information in step 1008G. The LBT failure report may be transmitted through a Downlink RAN Configuration Transfer message.

The CU of the last serving node can forward all and/or part of the information in the received LBT failure report to the DU of the last serving node.

The last serving node (or the CU of the last serving node or the DU of the last serving node) can make self-optimization decisions and/or update configuration based on the received LBT failure report.

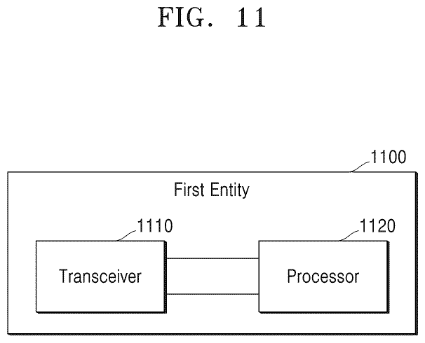

Next, FIG. 11 illustrates a schematic diagram of a first entity 1100 according to embodiments of the present disclosure.

As shown in FIG. 11, the first entity 1100 according to embodiments of the present disclosure may include a transceiver 1110 and a processor 1120. The transceiver 1110 may be configured to transmit and receive signals. The processor 1120 may be coupled to the transceiver 1110 and may be configured to (e.g., control the transceiver 1110 to) perform methods performed by a first entity according to embodiments of the present disclosure.

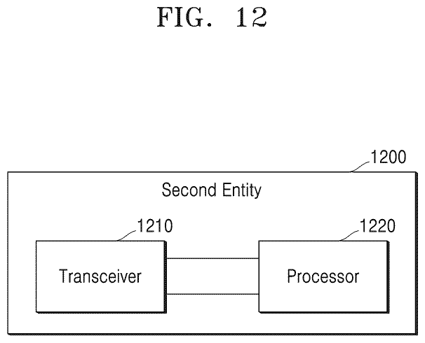

FIG. 12 illustrates a schematic diagram of a second entity 1200 according to embodiments of the present disclosure.

As shown in FIG. 12, the second entity 1200 according to embodiments of the present disclosure may include a transceiver 1210 and a processor 1220. The transceiver 1210 may be configured to transmit and receive signals. The processor 1220 may be coupled to the transceiver 1210 and may be configured to (e.g., control the transceiver 1210 to) perform methods performed by a second entity according to embodiments of the present disclosure. A processor may also be referred to as a controller.

Embodiments of the present disclosure also provide a computer-readable medium having stored thereon computer-readable instructions which, when executed by a processor, implement any method according to embodiments of the present disclosure.

The methods performed by a first entity and/or a second entity in a wireless communication system provided by the present disclosure can enable the first entity and/or the second entity to efficiently acquire auxiliary information to make network self-optimization decisions such as decision-making of mobile load balancing and decision-making of mobile robust optimization.

Various embodiments of the present disclosure may be implemented as computer-readable codes embodied on a computer-readable recording medium from a specific perspective. A computer-readable recording medium is any data storage device that can store data readable by a computer system. Examples of computer-readable recording media may include read-only memory (ROM), random access memory (RAM), compact disk read-only memory (CD-ROM), magnetic tape, floppy disk, optical data storage device, carrier wave (e.g., data transmission via the Internet), etc. Computer-readable recording media can be distributed by computer systems connected via a network, and thus computer-readable codes can be stored and executed in a distributed manner. Furthermore, functional programs, codes and code segments for implementing various embodiments of the present disclosure can be easily explained by those skilled in the art to which the embodiments of the present disclosure are applied.

It will be understood that the embodiments of the present disclosure may be implemented in the form of hardware, software, or a combination of hardware and software. The software may be stored as program instructions or computer-readable codes executable on a processor on a non-transitory computer-readable medium. Examples of non-transitory computer-readable recording media include magnetic storage media (such as ROM, floppy disk, hard disk, etc.) and optical recording media (such as CD-ROM, digital video disk (DVD), etc.). Non-transitory computer-readable recording media may also be distributed on computer systems coupled to a network, so that computer-readable codes are stored and executed in a distributed manner. The medium can be read by a computer, stored in a memory, and executed by a processor. Various embodiments may be implemented by a computer or a portable terminal including a controller and a memory, and the memory may be an example of a non-transitory computer-readable recording medium suitable for storing program(s) with instructions for implementing embodiments of the present disclosure. The present disclosure may be realized by a program with code for concretely implementing the apparatus and method described in the claims, which is stored in a machine (or computer)-readable storage medium. The program may be electronically carried on any medium, such as a communication signal transmitted via a wired or wireless connection, and the present disclosure suitably includes its equivalents.

What has been described above is only the specific implementation of the present disclosure, but the scope of protection of the present disclosure is not limited thereto. Anyone who is familiar with this technical field may make various changes or substitutions within the technical scope disclosed in the present disclosure, and these changes or substitutions should be covered within the scope of protection of the present disclosure. Therefore, the scope of protection of the present disclosure should be based on the scope of protection of the claims.

1-15. (canceled)

16. A method performed by a first entity in a wireless communication system, the method comprising:
receiving, from a second entity, at least one of a user equipment (UE) information request message or a message to request listen before talk (LBT) failure information; and
transmitting, to the second entity, the LBT failure information, wherein the LBT failure information is used for self optimization of the second entity.

17. The method of claim 16, wherein the LBT failure information comprises information indicating a number of LBT failures.

18. The method of claim 17, wherein the LBT failure information further comprises a LBT failure indication associated with consistent uplink LBT failures.

19. The method of claim 17,
wherein the LBT failures are downlink LBT failures, and
wherein the LBT failure information further comprises UE identification information.

20. The method of claim 16, wherein the transmitting of the LBT failure information comprises:
transmitting a UE information response message comprising the LBT failure information.

21. The method of claim 20, wherein the UE information response message comprises a random access (RA) report comprising the LBT failure information.

22. The method of claim 20, wherein the UE information response message comprises a radio link failure (RLF) report comprising the LBT failure information.

23. The method of claim 16, wherein the self optimization comprises mobility robustness optimization.

24. The method of claim 16,
wherein the message to request the LBT failure information is a Xn message comprising UE identification information and information indicating a LBT failure information request, and
wherein the transmitting of the LBT failure information comprises:
transmitting an access and mobility indication message comprising the LBT failure information.

25. The method of claim 16,
wherein the first entity is a gNB-distributed unit (DU) and the second entity is a gNB-centralized unit (CU),
wherein the message to request the LBT failure information is a F1 message comprising UE identification information and information indicating a LBT failure information request, and
wherein the transmitting of the LBT failure information comprises:
transmitting an access and mobility indication message comprising the LBT failure information.

26. A first entity in a wireless communication system, comprising:
a transceiver; and
at least one processor coupled to the transceiver and configured to:
receive, from a second entity, at least one of a user equipment (UE) information request message or a message to request listen before talk (LBT) failure information; and
transmit, to the second entity, the LBT failure information, wherein the LBT failure information is used for self optimization of the second entity.

27. The first entity of claim 26, wherein the LBT failure information comprises information indicating a number of LBT failures.

28. The first entity of claim 27, wherein the LBT failure information further comprises a LBT failure indication associated with consistent uplink LBT failures.

29. The first entity of claim 27,
wherein the LBT failures are downlink LBT failures, and
wherein the LBT failures information further comprises UE identification information.

30. The first entity of claim 26, wherein the at least one processor is further configured to transmit a UE information response message comprising the LBT failure information.

31. The first entity of claim 30, wherein the UE information response message comprises a random access (RA) report comprising the LBT failure information.

32. The first entity of claim 30, wherein the UE information response message comprises a radio link failure (RLF) report comprising the LBT failure information.

33. The first entity of claim 26, wherein the self optimization comprises mobility robustness optimization.

34. A method performed by a second entity in a wireless communication system, the method comprising:
transmitting, to a first entity, at least one of a user equipment (UE) information request message or a message to request listen before talk (LBT) failure information;
receiving, from the first entity, the LBT failure information; and
performing self optimization based on the LBT failure information.

35. A first entity in a wireless communication system, comprising:
a transceiver; and
at least one processor coupled to the transceiver and configured to:
transmit, to a first entity, at least one of a user equipment (UE) information request message or a message to request listen before talk (LBT) failure information;
receive, from the first entity, the LBT failure information; and
perform self optimization based on the LBT failure information.
